(19) United States
(12) Patent Application Publication
(10) Pub. No.: US 2025/0054273 A1
(43) Pub. Date: Feb. 13, 2025

(54) Methods and systems for determining similarities between media

(71) Applicant: Seminal One Pty Ltd, Melbourne (AU)

(72) Inventors: Ward WILLIAMS, Melbourne (AU); Thananjeyan SHANMUGANATHAN, Melbourne (AU); Nai WONG, Melbourne (AU); Kuoyuan LI, Melbourne (AU)

(21) Appl. No.: 18/799,198

(22) Filed: Aug. 9, 2024

(30) Foreign Application Priority Data
Aug. 11, 2023 (AU) 2023902548

(51) Int. Cl. G06V 10/75; G06V 10/24; G06V 10/26; G06V 10/44; G06V 10/72; G06V 10/74

(52) U.S. Cl. CPC G06V 10/751; G06V 10/24; G06V 10/26; G06V 10/44; G06V 10/72; G06V 10/761

(57) ABSTRACT

A method relating to determining similarities between media, and systems and computer-readable media used to implement said method, includes determining an input image for comparison with a plurality of stored images in a media database; vectorising the input image to determine an input image vector representation; and comparing the input image with each of the plurality of stored images in a media database. The method further comprises outputting a set of direct matches and a set of exact matches as a detected comparison output for the input image. Further embodiments also relate to systems and methods for associating digital media with provenance information and creating verified copyright assets for attributing copyright ownership using the systems and methods disclosed herein.

### TECHNICAL FIELD

Embodiments generally relate to methods and systems for comparing media, and in some embodiments, for segmenting media, and comparing segments of that media to stored media to determine similarities. Some embodiments relate to methods and systems for tracking digital media, establishing provenance of digital media and determining copyright infringement.

### BACKGROUND

Copyright law originated from The Berne Convention for the Protection of Literary and Artistic Works, which is an international treaty that sets out minimum standards for copyright protection across its member countries. The treaty was first adopted in Berne, Switzerland in 1886, and it has since been revised and amended several times. The Berne Convention aims to provide a framework for the protection of the rights of creators of literary and artistic works, such as writers, musicians, artists, and filmmakers. The treaty also establishes minimum standards for the duration of copyright protection and the rights of reproduction, translation, and public performance of works. The treaty has been adopted by over 170 countries and is administered by the World Intellectual Property Organization (WIPO).

One of the founding principles established in the treaty from the Berne Convention is the principle of automatic protection, which describes that protection must not be compliant with any formality. Unlike other forms of intellectual property, in the absence of a maintained official register for copyright, there is no way to monitor for infringement and assess validity of protections awarded to creators.

When infringement of intellectual property rights on digital media occurs, most often the owner of these rights is unaware. In circumstances in which they are made aware, the procedure to prove ownership and pursue legal action is time-consuming, ad hoc and burdensome.

Digital media matching algorithms are designed to compare two pieces of digital media (such as images, audio, video, and the like) and determine if they match. However, these algorithms rely on direct copying and/or reproduction of digital media, and struggle to identify similarities when digital media has undergone various transformations and/or modifications. In today's digital world, digital media are frequently modified for various purposes, which can prevent digital media matching algorithms from accurately identifying indirect matches between digital media. Additionally, it is difficult to detect parts of media which have been taken and used in derivative or composite works, that is, where there is not a direct copy of the media.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

Some embodiments relate to a method, including: determining an input image for comparison with a plurality of stored images in a media database; vectorising the input image to determine an input image vector representation; comparing the input image vector representation with each of the plurality of stored images in a media database, wherein said comparing comprises, for each stored image of the plurality of stored images: determining a spatial distance between the input image vector representation and a stored vector representation of the stored image; and responsive to the spatial distance between the input image vector representation and the stored vector representation being within a predetermined distance threshold, outputting the stored image as an exact match image to a set of exact matches; responsive to the spatial distance between the input image vector representation and the stored vector representation being outside of the predetermined distance threshold, but within a secondary predetermined distance threshold, outputting the stored image as a candidate image to a set of direct matches; refining the set of direct matches by comparing each candidate image in the set of direct matches to the input image based on at least one of key points, alignment and structural similarity; and outputting the set of direct matches and the set of exact matches as a detected comparison output for the input image.

In some embodiments, the method may further include: identifying one or more targets of interest within the input image; segmenting the input image into a plurality of image segments based on the targets of interest; and vectorising each of the plurality of image segments to determine respective image segment vector representations.

In some embodiments, the method may further comprise: comparing each of the image segment vector representations with each of the plurality of stored images in the media database.

Comparing each of the image segment vector representations with each of the plurality of stored images, may comprise, for each of the plurality of image segments: determining a spatial distance between an image segment vector representation and a stored vector representation of a stored image for each of the plurality of stored images; responsive to the spatial distance between the image segment vector representation and the stored vector representation being within a predetermined distance threshold, outputting the stored image as an exact segment match to a set of exact segment matches; responsive to the spatial distance between the image segment vector representation and the stored vector representation being outside of the predetermined distance threshold, but within a secondary predetermined distance threshold, outputting the stored image as a candidate image to a set of direct segment matches associated with the image segment.

In some embodiments, the method may further comprise: refining the set of direct segment matches associated with the image segment by comparing each candidate image to the image segment based on at least one of key points, alignment and structural similarity; adding the set of exact segment matches associated with the image segment to a combined set of exact segment matches; adding the set of direct segment matches associated with the image segment to a combined set of direct segment matches; outputting the combined set of image segment direct matches and the combined set of exact matches for the plurality of image segments as a second detected comparison output for the input image.

Segmenting the input image into a plurality of image segments may include: splitting the input image into a plurality of smaller images based on the identified targets of interest; and detecting boundaries in each of the smaller images around the targets of interest; and segmenting the target of interest from the smaller image to define an image segment.

In some embodiments, the targets of interest may be identified by an object detection algorithm or object detection model. The input image may be segmented using a segmentation model. The segmentation model may be a SAM (Segment Anything Model).

Comparing the input image vector representation with a plurality of stored images in a media database may include comparing the input image vector representation to a stored image vector representation. Comparing the input image vector representation to a stored image vector representation may comprise calculating a spatial distance between the input image vector representation and the stored image vector representation. Calculating a spatial distance may include using Euclidean distance.

In some embodiments, refining the set of direct matches may comprise resizing each candidate image to the same scale as the input image. Refining the set of direct matches may comprise: generating one or more variations of each candidate image; and adding the one or more variations of each candidate image to the set of direct matches for comparison with the input image.

Generating one or more variations of each candidate image may include applying a transformation to the candidate image. In some embodiments, refining the set of direct matches may comprise: generating one or more variations of the input image; and comparing the one or more variations of the input image to each of the candidate images.

Generating one or more variations of the input image may comprise applying a transformation to the input image. The transformation may include at least one of rotating, scaling, flipping, warping, cropping, inverting, blurring, and sharpening the input image. The transformation may comprise adjusting at least one of subclass, grayscale, brightness, contrast, hue, saturation, and luminosity of the input image. The transformation may comprise applying at least one of histogram equalisation, noise addition, sepia tone, one or more filters, a watermark, and/or a frame to the input image.

In some embodiments, generating one or more variations of the input image may comprise generating a horizontally flipped variation of the input image and a vertically flipped variation of the input image.

Comparing each candidate image in the set of direct matches to the input image based on at least key points may comprise: applying Scale Invariant Feature Transform (SIFT) to extract a plurality of key points within the input image; applying SIFT to extract a plurality of key points within each candidate image; and determining the number of key points geometrically align between the key points of the input image and the key points of each candidate image.

Refining the set of direct matches may further comprise removing candidate images from the set of direct matches where the number of geometrically aligned key points between an input image and a candidate image is below a predetermined threshold.

Comparing each stored image in the set of direct matches to the input image based on at least alignment may comprise: aligning each candidate image to have the same orientation as the input image; applying SIFT to the aligned candidate images to extract a plurality of key points within each aligned candidate image; and determining the number of key points that geometrically align between the key points of the input image and the key points of each aligned candidate image.

Refining the set of direct matches may further comprise removing candidate images from the set of direct matches where the number of geometrically aligned key points between the input image and an aligned candidate image is below a predetermined threshold.

Comparing each stored image in the set of direct matches to the input image based on at least structural similarity may comprise: calculating a structural similarity index (SSIM) between the input image and each candidate image.

Refining the set of direct matches may further comprise removing candidate images from the set of direct matches where the SSIM between the input image and a candidate image is below a predetermined threshold.

In some embodiments, the comparison output may include a similarity measure. In some embodiments, the detected comparison output may be collated into a list, wherein the list contains all elements in the set of exact matches and the set of direct matches.

Some embodiments relate to a system, including: one or more processors; and memory comprising computer executable instructions, which when executed by the one or more processors, cause the system to perform any of the methods described herein.

Some embodiments relate to a computer-readable storage medium storing instructions that, when executed by a computer, cause the computer to perform any of the methods described herein.

Some embodiments relate to a system, including: an encoder, configured to: determine an input image for comparison with a plurality of stored images in a media database; and vectorise the input image to determine an input image vector representation; a comparison module, configured to: compare the input image vector representation with each of the plurality of stored images in a media database, wherein said comparing comprises, for each stored image of the plurality of stored images: determine a spatial distance between the input image vector representation and a stored vector representation of the stored image; and responsive to the spatial distance between the input image vector representation and the stored vector representation being within a predetermined distance threshold, output the stored image as an exact match image to a set of exact matches; responsive to the spatial distance between the input image vector representation and the stored vector representation being outside of the predetermined distance threshold, but within a secondary predetermined distance threshold, output the stored image as a candidate image to a set of direct matches; refine the set of direct matches by comparing each candidate image in the set of direct matches to the input image based on at least one of key points, alignment and structural similarity; and an output module, configured to output the set of direct matches and the set of exact matches as a detected comparison output for the input image.

Some embodiments relate to a computer-readable medium storing instructions that, when executed by a processor, cause the processor to perform a method comprising: determining an input image for comparison with a plurality of stored images in a media database; vectorising the input image to determine an input image vector representation; comparing the input image vector representation with each of the plurality of stored images in a media database, wherein said comparing comprises, for each stored image of the plurality of stored images: determining a spatial distance between the input image vector representation and a stored vector representation of the stored image; and responsive to the spatial distance between the input image vector representation and the stored vector representation being within a predetermined distance threshold, outputting the stored image as an exact match image to a set of exact matches; responsive to the spatial distance between the input image vector representation and the stored vector representation being outside of the predetermined distance threshold, but within a secondary predetermined distance threshold, outputting the stored image as a candidate image to a set of direct matches; refining the set of direct matches by comparing each candidate image in the set of direct matches to the input image based on at least one of key points, alignment and structural similarity; and outputting the set of direct matches and the set of exact matches as a detected comparison output for the input image.

Some embodiments relate to a method for associating digital media with provenance information, comprising: receiving a digital medium to be associated with provenance information; determining the uniqueness of the digital medium by comparing the digital medium with the stored digital media in the database; responsive to verifying the uniqueness of the digital medium, generating a unique digital record for the digital medium; determining provenance information related to the digital medium; verifying the provenance information; writing an association between the digital medium and the provenance information; generating a cryptographic token representing the association between the digital medium and the provenance information as a verified copyright asset; minting the cryptographic token to a blockchain ledger to create an immutable record.

In some embodiments, the digital medium may be an image, video, or audio recording.

The provenance information may include at least one or authorship information, ownership information, creation information, publication information, and/or time stamps associated with the digital medium.

In some embodiments, the method may further comprise verifying the provenance information of the digital medium by determining details associated with creation of the digital medium and/or publication of the digital medium.

In some embodiments, the method may further comprise verifying the provenance information of the digital medium by verifying the authorship information and/or ownership information.

In some embodiments, the method may further comprise establishing an ownership link between the digital medium and a verified entity based on the verified ownership information. The method may further comprise associating metadata with the cryptographic token, wherein the metadata includes information about the digital medium and/or the copyright status of the digital medium.

The method may further comprise enabling the transfer of ownership of the cryptographic token through blockchain transactions. In some embodiments, the method may further comprise providing a mechanism for updating the metadata associated with the cryptographic token to reflect any changes in the copyright status of the digital medium.

In some embodiments, the method may further comprise determining authorship information from the provenance information, and constructing one or more Generative Artificial Intelligence (GenAI) models by training the model with a set of one or more digital media associated with the same authorship information, wherein the one or more GenAI models may be configured to generate one or more AI-derived digital media.

In some embodiments, the set of one or more digital media associated with the same authorship information may be used to create a digital fingerprint associated with the authorship information. The digital fingerprint may be used to configure the one or more GenAI models to generate one or more AI-derived digital media having a substantially similar style of digital media associated with the digital fingerprint.

In some embodiments, the method may further include providing a mechanism for generating one or more AI-derived digital media using the one or more trained GenAI model.

In some embodiments, the method may further include establishing an authorship link between the one or more AI-derived digital media and the authorship information; generating a cryptographic token representing each of the one or more AI-derived digital media and the authorship link as a verified copyright asset; and minting the cryptographic token onto a blockchain ledger to create an immutable record of the authorship associated with each of the one or more AI-derived digital media.

Some embodiments, relate to a system for associating digital media with author information, comprising: a digital medium module configured to receive a digital medium to be associated with provenance information; a comparison module configured to determine the uniqueness of the digital medium by comparing the digital medium with the stored digital media in a database; a generation module configures to, responsive to verifying the uniqueness of the digital medium, generate a unique digital record for the digital medium; a provenance information module configured to determine provenance information related to the digital medium; a verification module configured to verify the provenance information; an association module configured to write an association between the digital medium and the verified provenance information; a tokenisation module configured to generate a cryptographic token representing the association between the digital medium and the provenance information as a verified copyright asset; and a minting module configured to mint the cryptographic token to a blockchain ledger to create an immutable record.

Some embodiments relate to a method, including: determining an input image for comparison with a plurality of stored images in a media database; vectorizing the input image to determine an input image vector representation of the input image; comparing the input image vector representation with each of the plurality of stored images in a media database, wherein said comparing comprises, for each of the plurality of stored images: determining a spatial distance between the input image vector representation and the respective stored image; and determining a comparison output for the respective input image vector representation and the stored image pair based on the spatial distance; returning the comparison output for each of the respective input image vector representation and the stored image pairs when the comparison output is below a predetermined threshold.

In some embodiments, the method may further include: identifying one or more targets of interest within the input image; segmenting the input image into a plurality of image segments based on the targets of interest; vectorizing each of the plurality of image segments to determine respective image segment vector representations; comparing each of the image segment vector representations with each of the plurality of stored images in the media database, wherein said comparing comprises, for each of the plurality of stored images; determining a spatial distance between each image segment vector representation and each of the plurality of stored images; and determining a comparison output for each of the respective image segment vector representation and the stored image pair based on the spatial distance; returning the comparison output for each of the respective image segment vector representation and the stored image pairs when the comparison output is below a predetermined threshold.

In some embodiments, segmenting the input image into a plurality of image segments may include: splitting the input image into a plurality of smaller images based on the identified targets of interest; and detecting boundaries in each of the smaller images around the targets of interest and segmenting the target of interest from the smaller image to define an image segment.

Comparing the input image vector representation with a plurality of stored images in a media database may include calculating a spatial distance between the image vector representation and vectors of the plurality of stored images. Calculating a spatial distance may include using one or more of: (i) Euclidean distance; (ii) Hamming distance; (iii) Manhattan distance; and (iv) Minkowski distance.

The targets of interest may be identified by an object detection algorithm or object detection model. The object detection model may be an open-set object detector. In some embodiments, the open-set object detector may be grounding DINO.

In some embodiments, the input image may be segmented using a segmentation model. The segmentation model may be SAM (Segment Anything Model). In some embodiments, Grounded-SAM may be used to segment the input image.

Comparing the input image and the stored images may use a local feature detection and comparison algorithm. The local feature detection and comparison algorithm may include SIFT, FLANN, and/or RANSAC. Comparing the image vector representation and the stored images may one or more of pixel values, colour histograms, and/or a convolutional neural network.

The comparison output may include a similarity measure. In some embodiments, returning the comparison output may include returning the stored image of the respective input image vector representation and the stored image pair.

Comparison outputs may be collated into a list, wherein the list may contain all comparison outputs for the input image and each of the stored images which are below the predetermined threshold.

Some embodiments relate to a system, including: one or more processors; and memory comprising computer executable instructions, which when executed by the one or more processors, cause the system to perform any of the methods described herein.

Some embodiments relate to a computer-readable storage medium storing instructions that, when executed by a computer, cause the computer to perform any of the methods described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Various ones of the appended drawings merely illustrate example embodiments of the present disclosure and cannot be considered as limiting its scope.

FIG. 1A is a flow diagram illustrating a method for determining similarities between media by performing a comparison of an input image with a media database, according to some embodiments;

FIG. 1B is a flow diagram illustrating a method of segmenting an image for comparison, according to some embodiments;

FIG. 2 is a diagram illustrating the process of segmenting an input image into a plurality of image segments, according to some embodiments;

FIG. 3 is a process flow diagram of a method for determining similarities between images, according to some embodiments;

FIG. 4 is a diagram illustrating image vectorisation, according to some embodiments;

FIG. 5 is a diagram of a comparison of input vector representations and stored vector representations, according to some embodiments;

FIG. 6 is a diagram of the set of exact matches and the set of direct matches output as a result of the vector comparison in FIG. 5, according to some embodiments;

FIG. 7 is a diagram of the refinement of the set of direct matches of FIG. 6, according to some embodiments;

FIG. 8 is a process flow diagram of a method for determining similarities between image segments and stored images, according to some embodiments;

FIG. 9 is a process flow diagram of a method for refining a set of direct matches, according to some embodiments;

FIG. 10 is a process flow diagram of a method for determining similarities between digital media, according to some embodiments;

FIG. 11 is a block diagram of a system configured to perform the methods of FIGS. 1A, 1B, 3, 8, 9, and 10, according to some embodiments;

FIG. 12 is a process flow diagram of a method for associating digital media with provenance information, according to some embodiments; and

FIG. 13 is a block diagram of a system configured to perform a method for associating digital media with provenance information, according to some embodiments.

### DESCRIPTION OF EMBODIMENTS

Embodiments generally relate to methods and systems for determining similarities between media. For example, this may involve comparing, segmenting and/or tracking digital media such as images, audio, video, text, or the like, including instances of digital media as they appear in a variety of locations, for example, across the web. In some embodiments, input digital media are compared to a database of collected and stored digital media to determine whether such media already exists in the database. In some embodiments, the input digital media is broken down into segments such that segments of the digital media may be compared to all or part of the stored digital media. In addition to being segmented, derivatives of the media may be generated from all or part of the input digital media to compare against stored digital media.

Embodiments of the systems and methods described herein may provide a robust and flexible method that accurately identifies matches between digital media even when the digital media has been transformed and/or modified.

The methods and systems described herein may be used to track existing intellectual property rights within digital media and/or determine whether input digital media, either in whole or in part, contains registered or unregistered intellectual property rights. In addition, the methods and/or systems described herein may be used to track where media and/or images are being used, and/or how they are being used, for example, in derivative works. Embodiments of the present disclosure also relate to methods for establishing a relationship between digital media and copyright and establishing provenance information associated with digital media. Embodiments of the present disclosure may also relate to tokenising the provenance information related to digital media, so as to provide an immutable record of the provenance of the digital media which may include creation and publication timelines, authorship information and ownership information. In some embodiments, all transactions and/or developments relating to a piece of digital media, such as change of ownership, or the addition of licensing details, may also be tokenised and/or stored in an immutable data structure. The tokens may be minted into a blockchain ledger, creating a shared and immutable record, enabling the ownership details and transactions related to the digital media to be verified at any point in time.

Some embodiments may relate to building Generative AI (GenAI) models, and training GenAI models with one or more digital media assets having at least part of the same provenance information, for example, the same authorship information. This can be used to create a unique fingerprint that enables the GenAI model to generate AI-derived digital media in the style of a particular author or creator. Some embodiments may provide a facility to generate AI-derived digital media out of the trained GenAI model, and may attribute and/or establish ownership using tokenisation based on the AI-derived digital media. That is, the AI-derived digital media that is generated using the fingerprint or style of a particular author can be attributed ownership or partial ownership upon generation of the AI-derived digital media.

The methods and systems are configured to process digital media. For example, the digital media may include, but is not limited to images, videos or video frames, graphics, artworks, and photographs, audio, music, audiobooks, recordings, animations (2D and 3D), motion graphics, 3D models, and text-based media such as books, articles, blogs, posts and the like.

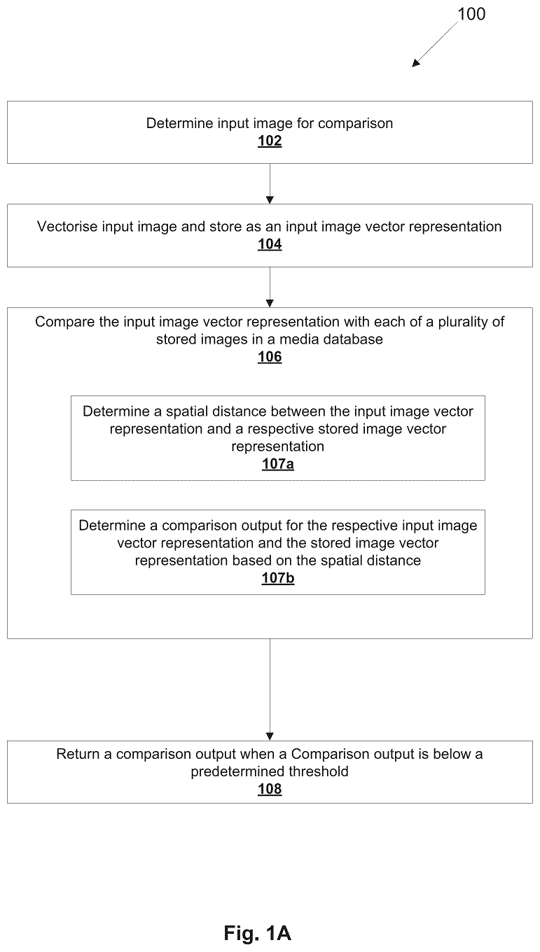

FIG. 1A is a flow diagram illustrating a method 100 for determining similarities between media by performing a comparison of an input image with a media database, according to some embodiments. The method 100 may be performed by a system, such as system 1100 or system 1300, as described below.

The method 100 includes, at 102, determining an input image for comparison with a plurality of stored images in a media database. The input image may be received through a web application or client application, such as an online portal. In some embodiments, the input image may be received from an external database, selected for input by a selection means, or accessed from another system. In some embodiments, a system may extract the image from a database and/or data store. In one example, a user may upload an input image through a client application for comparison using the methods described herein. In some embodiments, the user may upload the input image after a “create” event is initiated, for example, by selecting a “create” button on an application.

In some embodiments, the input image is analysed to determine whether the input image meets predefined image requirements for the comparison to be performed. For example, the input image may be analysed to determine whether it meets a minimum pixel requirement for comparison and/or segmentation. In some embodiments, the input image may be analysed and/or queried to determine whether manipulation of the input image is required. For example, manipulation may include breaking the image down into segments to perform comparisons of segments of the image with stored images, or generating variations and/or derivates from the input image and/or image segments.

At 104, the input image is vectorised to determine or generate a vector representation of the input image. In some embodiments, vectorising the input image may include feeding the input image into a deep learning model, such as a CLIP (Contrastive Language-Image Pretraining) encoder. The CLIP encoder may be configured to encode the input image into a one dimensional (1D) vector. In some embodiments, the 1D vector may have a dimensionality of 768. In some embodiments, the 1D vector may have another dimensionality.

The input image vector representation may be stored. For example, it may be stored in a database and/or data store. Vectorising the input image may include converting the input image into a numeric representation of a single vector. The vector may be stored as an input image vector representation and associated with the input image. The input image vector representation may be stored on an internal or external database. In some embodiments, it may be stored temporarily for comparison, before being moved to another database, or deleted. The input image vector representation may be stored as a dense vector representation type or a sparse vector representation type.

At 106, the input image vector representation is then compared with each of a plurality of stored images in a media database. In some embodiments, the media database may include a collection of images that have been selected, collected, identified and/or collated into a media database. In some embodiments, the media database may include images, or it may contain mixed digital media such as images, videos, graphics, documents and the like. For example, the media database may include a collection of digital media, for example, images or visual representations of works which are known works that have been published. In some embodiments, this may include media which is a known work of copyright, works in the public domain, and works which are still under copyright. In some embodiments, the media database may include media which are registered forms of intellectual property, such as designs and/or trademarks. In some embodiments, the media database may comprise Open Search Vector DB. The data collection for the media database may be performed manually, or may include automatic collection, for example, automatically collecting images from web applications or external databases using scrapers or crawlers. In some embodiments, the data collection for the media database may include collecting media from an particular author or owner and uploading these to the database, collecting media through publicly available websites, and/or collecting media through input into a system such as system 1100 or 1300, to determine similarities between the uploaded media and the database. Where no similarities are determined, the input media may be stored in the database for future comparisons.

Comparing the input image vector representation with each of the plurality of stored images may include, for each of the plurality of stored images, taking the input image vector representation and determining and/or calculating the spatial distance between the input image vector representation and the respective vector of a stored image from the media database (107a). Then, the comparison includes determining a comparison output for the respective input image vector representation and the stored image pair based on the spatial distance (107b). The comparison 106 may be performed across all stored images in the media database, or a subset of stored images in the media database. In some embodiments, methods may be used to define a subset of stored images to select for comparison in the media database, including image annotations, metadata or manual selection. In some embodiments, a set of computer vision algorithms may be applied to efficiently compare the input image with the stored images in the media database, for example, by determining and/or predicting candidate matches or potential similarities with the stored images.

In some embodiments, determining the spatial distance may include calculating the Euclidean distance between two vectors. In some embodiments, the spatial distance calculation may include using one or more of Hamming distance, Manhattan distance, or Minkowski distance. In some embodiments, the comparison may include identifying similar vectors to the input image vector representation. For example, the comparison may include using a KNN (k-nearest neighbour) algorithm to identify images from the media database with similar vectors. In some embodiments, similar vector images may be identified when the spatial distance is below a predefined threshold. In situations where the calculated spatial distance is low, this indicates that the input image is similar in appearance to one of the stored images. In situations where the calculated spatial distance is high, this indicates that the input image is not similar in appearance to one of the stored images.

The predefined threshold may be adjusted, modified and/or changed as matching of input images occurs. For example, in some embodiments the predefined threshold may be adjusted where it is determined that there are too many exact and/or direct matches, and the returned results should be refined further before being output. Additionally, the matching methods described herein may utilise a separate and independent test dataset of images to test the accuracy of the methods, and the predefined threshold may be updated based on continuous testing to improve the accuracy of the methods.

At 107b, once the input image vector representation has been compared with a stored image, a comparison output is determined for each image vector representation and stored image pair, based on the result of the spatial distance determination. The comparison output may include a numerical representation of the calculated spatial distance, and/or may include a similarity measure. In some embodiments, the similarity measure may include at least the spatial distance between the input image vector representation and the stored image vector representation. In some embodiments, the comparison output may include information about the input image and/or stored image to which it relates, including but not limited to names, metadata, annotated information and/or data, and location. In some embodiments, the comparison output may include the input image and/or the stored image to which it relates. That is, the comparison output may provide a visual representation of the similarity, for example, by showing the input image and stored image side-by-side, or in the same field of view.

At 108, the comparison output is returned for each of the respective input image vector representation and the stored image pairs when the comparison output is below a predetermined threshold. The predetermined threshold may be a predetermined spatial distance threshold. In some embodiments, the predetermined spatial distance threshold may be a measure of Euclidean distance. In some embodiments, a plurality of comparison outputs are returned. In some embodiments, returning the comparison output includes returning a similarity measure and/or returning the stored image of the respective input image vector representation and the stored image pair. In some embodiments, the comparison output may be a measure of the calculated spatial distance between the two vectors of the input image and the stored image. In some embodiments, the comparison output may be collated into a list, wherein the list contains all comparison for the input image and each of the stored images which are below the predetermined threshold. For example, the comparison output may be collated to provide a report on which stored images have a high similarity measure with the input image. In some embodiments, the detected comparison outputs may be queried. For example, to determine whether the similarity measure is valid, to determine whether the stored image with a high similarity measure has protected intellectual property rights, or to perform further analysis to validate the similarity measure, for example, by using computer vision and/or machine learning algorithms for additional comparison.

In some embodiments, where the similarity measure between an input image and a stored image is too high, the comparison output may not be returned. For example, where the similarity measure is calculated to be high, it indicates that there is not a sufficient level of similarity between the input image and a stored image, that is, that the vectors are too far apart, and therefore it may not be relevant to return the comparison output. However, where the similarity measure is calculated to be low between the input image and a stored image in the media database, this indicates that there is a high level of similarity between the two images and the comparison output is returned. In some embodiments, the comparison output is returned if it is equal to or below a predefined threshold. In some embodiments, the comparison output is returned if the similarity measure is below a predetermined threshold. In some embodiments, a comparison output below a predetermined threshold may be identified as an infringement event. In some embodiments, the comparison output may be grouped into one or more categories and/or probabilities which correspond to a likelihood of similarity. For example, the comparison output may provide an indication of “potential” for similarity or “very high potential” for similarity between images. In some embodiments, the categories may be used to flag images for manual review. In some embodiments, a comparison output which has a value above a predetermined threshold, but below a secondary predetermined threshold may be classified as a “direct match”, in which the input image is a direct match, that is, similar or substantially the same, to the stored image against which it was compared, but is distinct from an exact match.

Direct match may refer to a 100% match between the input image and the stored image, or may include substantially the same, but have minor changes in pixelation, and/or may also include colour changes including, but not limited to, exposure, tint, highlights, contrast, shadows. For example, an original photograph when compared with the same photograph having a filter applied which adjusts the highlights, exposure and contrast will still be classed as a “direct match” to the original photograph. In some embodiments, direct match may refer to a 90% to 99% match between the input image and the stored image. In some embodiments, a direct match may include a match between the stored image and one or more variations or modifications of the input image, wherein the variations and/or modifications may be minor or substantial. Direct match images may include variations such as, but not limited to, subclass, rotation, scaling, slipping, warping, cropping, grayscale, brightness, contrast, inversion, histogram equalisation, HSL adjustments, blurring, sharpening, noise addition, sepia tone, watermarks and frames. Computer vision techniques including local feature detection and extraction (for example by SIFT), local feature comparison (for example, by FLANN), and determining the number of geometrically aligned local features (for example, by RANSAC) are applied to enable modified images or image variations to be considered when determining similarities.

In some embodiments, where the input image is a direct match to a stored image in the media database, the stored image may be queried to determine whether the stored image is in the public domain, or whether it is protected by an intellectual property right, such as a copyright claim. This query may be determined by reading annotations attached to the stored image, metadata, or flags applied to the stored image. In some embodiments, this query may include querying a blockchain ledger to determine whether there exists a verified copyright asset in the form of a cryptographic token representing the association between the input image and its provenance information.

The method 100 may further include processes for segmenting the input image to compare image segments to data stored in the media database. FIG. 1B is a flow diagram illustrating a method 120 of segmenting an image for comparison, according to some embodiments. The method 120 may be performed by a system, such as system 1100 or system 1300, as described below. The method 120 includes, at 122 identifying one or more targets of interest within the input image. Targets of interest may be identified in the input image by using an object detector or an object detection algorithm. In some embodiments, the object detector may be an open-set object detector. For example, the open-set object detector, Grounding DINO, may be used to identify targets of interest. In some embodiments, the object detector may include DINO (DETR with Improved deNoising anchOr boxes), DETR (DEtection TRansformer) or GLIP (Grounded Language-Image Pre-training). In some embodiments, the object detector may include an algorithm for performing object detection including convolutional neural networks, such as region-based convolutional neural networks (R-CNN), Fast R-CNN, and/or YOLO (You Only Look Once). Targets of interest may be manually selected or input, or automatically detected. Targets of interest may include objects within an image, or they may include foregrounds, backgrounds, or any part thereof. In some embodiments, targets of interest may be applied to other media, such as splitting an audio signal into targets of interest, or a video clip into targets of interest.

In some embodiments, the object detector, for example the Grounding DINO model, is used to detect and square out an effective area around the target of interest. In some embodiments, the object detector applies boundary boxes around the targets of interest. The boundary boxes may include labels.

At 124, the input image is then segmented into a plurality of image segments based on the targets of interest. The input image may be segmented using a segmentation model such as the Segment Anything Model (SAM). In some embodiments, the segmentation model produces accurate object masks from the boundary boxes applied by the object detector. In some embodiments, a combination object detector and segmentation model are used to identify targets of interest and segment the input image into smaller images. For example, Grounded-SAM may be used which combines the Grounding DINO and Segment Anything Model.

Segmenting the input image into a plurality of image segments may include splitting the input image into a plurality of smaller images (125a) based on the boundary boxes of each of the identified targets of interest. Then, within each smaller image, detecting the boundaries around the targets of interest (125b), applying an object mask to the target of interest (125c), and segmenting the target of interest from the smaller image by removing the area of the smaller image outside of the mask to define an image segment (125d). In some embodiments, the entire image is segmented such that all image segments, if combined, form the original input image. In some embodiments, only some parts of the input image are segmented.

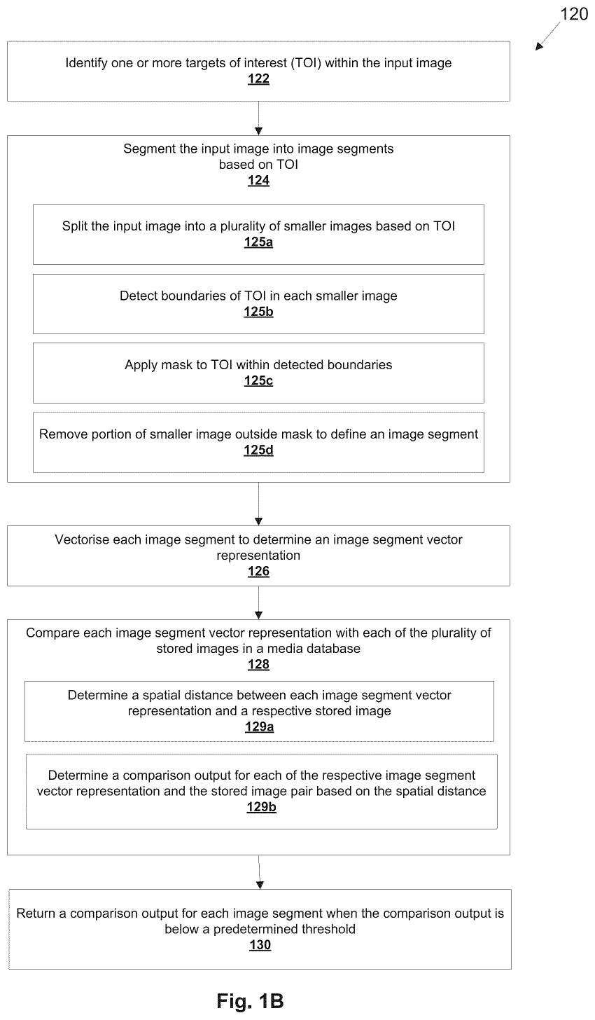

FIG. 2 is a diagram illustrating the process 200 of segmenting an input image into a plurality of image segments, according to some embodiments. The process 200 may be performed by a system, such as system 1100 or system 1300, as described below. The targets of interest 202 are identified in the input image 204, and boundary boxes 206 are applied around the targets of interest 202. The input image 204 is then split into a plurality of smaller images 208 defined by the boundary boxes 206. For each of the smaller images 208, the boundaries around the target of interest 202 are detected and an object mask 210 is applied to the target of interest 202 within the detected boundaries. Then the area 212 outside the mask is removed, thereby leaving image segments 214 that represent the target of interest.

Referring back to FIG. 1B, once the input image has been segmented into a plurality of image segments, each image segment is then vectorised at 126. Similar to the method by which the whole input image is vectorised, each individual image segment is converted into a numeric representation which consists of a single vector to determine respective image segment vector representations. These segment vector representations may then be stored. Each image segment will have a different segment vector representation based on the segmented part of the input image. In some embodiments, the image segment vector representations may be stored temporarily for comparison, before being moved to another database, or deleted. The image segment vector representation may be stored as a dense vector representation type or a sparse vector representation type.

At 128, each of the image segment vector representations are then compared with the plurality of stored images in the media database. In some embodiments, the plurality of stored images in the media database may have been segmented, enabling the image segment vector representations to be compared against stored image segments. In some embodiments, the image segment vector representations are compared with at least part of or a portion of a stored image for comparison. The comparison 128 may include, at 129a, for each of the plurality of stored images, determining a spatial distance between each image segment vector representation and each of the plurality of stored images. The comparison 128 may further include determining a comparison output for each of the respective image segment vector representations and the stored image pair based on the determined spatial distance (129b). For each image segment vector representation, the comparison 128 may be performed against each of the stored images in the media database, or a subset of stored images in the media database. In some embodiments, computer vision algorithms or machine learning algorithms may be applied to efficiently compare the image segments with the stored images in the media database, for example, by grouping image segments together for comparison, or by searching individually or in parallel for comparisons and similarities between image segments and stored images.

In some embodiments, image segments may be validated before they are used for comparison. For example, image segments which are output after segmentation may be manually reviewed by a user to determine which image segments are to be used for comparison. In some embodiments, an automated validation of the image segments may be performed to ensure that each segment has particular attributes. Validation may include ensuring image segments meet minimum system requirements, including pixel size and/or clarity.

At 129b, once the image segment vector representation has been compared with a stored image, a comparison output is determined for each image segment vector representation and stored image pair, based on the result of the spatial distance determination. The comparison output may include a numerical representation of the calculated spatial distance, and/or may include a similarity measure. In some embodiments, the similarity measure includes at least the calculated spatial distance. In some embodiments, the comparison output may include information about the image segment and/or stored image to which it relates, including but not limited to names, metadata, annotated information and/or data, and location. In some embodiments, the comparison output may include one or more image segments and/or the stored image to which it relates. That is, the comparison output may provide a visual representation of the similarity, for example, by showing an image segment and stored image side-by-side, or in the same field of view.

The comparison output may include a numerical representation of the calculated spatial distance between the image segment and all or part of a stored image. In some embodiments, where the comparison output between an image segment and a stored image is high, the comparison output may not be returned. For example, where the comparison output is calculated to be high, it indicates that there is not a sufficient level of similarity between the image segment and a stored image, and therefore it may not be relevant to return the comparison output. However, where the comparison output is calculated to be low between an image segment and a stored image in the media database, this indicates that there is a high level of similarity and that all or part of the stored image is similar to the image segment. That is, the vectors of the image segment and the stored image are spatially close, and therefore the comparison output may be returned. In some embodiments, more weight is given to the image segment for comparison, for example, the comparison output may be lower where the majority of an image segment appears in a stored image.

At 130, the comparison output is returned for each of the respective image segment vector representation and the stored image pair when the comparison output is below a predetermined threshold. In some embodiments, returning the comparison output includes returning a similarity measure and/or returning the stored image relating to the respective image segment vector representation and the stored image pair. In some embodiments, the comparison output may be collated into a list, wherein the list contains each image segment and each of the stored images which are below the predetermined threshold. For example, the comparison output may be collated to provide a report on which stored images have a high similarity measure with the input image. In some embodiments, the returned comparison output may be queried. For example, to determine whether the similarity measure relating to the image segment is valid, to determine whether the stored image with a high similarity measure to the image segment includes protected intellectual property rights, or to perform further analysis to validate the similarity measure between the image segment and a stored image, for example, by using computer vision or machine learning algorithms for additional comparison.

In some embodiments, the comparison output for each individual image segment is returned if it is equal to or below a predetermined threshold. In some embodiments, a comparison output below a predetermined threshold may be identified as an infringement event. In some embodiments, a stored image may contain similar features to multiple image segments. In this case, a combined comparison output may be returned which is an amalgamation of two or more comparison outputs where two image segments include similarities to the same stored image. In some embodiments, the comparison output may be returned as a report, listing all comparison which are below a predetermined threshold.

Some embodiments of the present disclosure relate to a multi-step process for determining similarities between digital media. In some embodiments, a two-step digital media matching process includes identifying exact matches where the digital medium is exactly matched with a medium in the database, and identifying variation matches, where the digital medium is matched with variations of the digital medium in the database. For example, where the digital medium is an image, the matching process includes identifying exact matches of the input image with one or more images in the database, and identifying variation matches, where the input image is matched with a variation of the image in the database. In other embodiments, identifying variation matches may include variations of the digital medium being matched with digital media in the database. For example, where the digital medium is an image, the matching process may include identifying variation matches, where variations of the input image are matched with images in the database. Variations may include changing one or more attributes or characteristics of the image such as changing colour, rotating, warping, and the like.

The two-step digital media matching process may be used on an input digital medium, where a match is identified based on the whole digital medium. In some embodiments, the two-step digital media matching process may be used on segments of a digital medium. For example, where the digital medium is an image, the matching process may be used on an input image to determine exact and direct matches for the whole input image. The matching process may also be used on a plurality of segment images, in which the segmented images are taken from the original input image, and the matching process is used to identify exact and direct matches for each of the segmented images. This may be referred to as segmentation matching or composite matching. In some embodiments, the two-step matching process may be implemented on a whole input image and a segmented version of the input image in parallel, such that identifying matches between the whole input image and the segmented version of the input image is performed at the same time.

The two-step process allows for an initial input digital medium to be searched and matched to identify exact matches in the first instance, creating a fast and simple process to identify direct copies for the digital medium that requires only a small amount of processing power. This is necessary when the media database could be extensive, and the time taken to check the input digital medium against every single piece of media in the database is large. Instead, by first identifying exact matches of the digital media through use of vector analysis and spatial distance, this can quickly reduce the amount of processing required to perform the method as the field of potential matches is narrowed down very quickly based on the vector representations. Further, in addition to identifying exact matches, variation matches are also identified to determine if the input digital medium is a derivation, variation or modification of any piece of media in the database. Again, using the vector representation enables the field of possible or candidate matches to be substantially narrowed, making the processing of variation matches much faster than it would be if it was necessary to go through each of the pieces of digital media in the database.

Furthermore, generating variations of the input digital media to compare against candidate matches enables more rapid and accurate identification of direct matches, and refining the candidate images based on image attributes allows for a more accurate set of direct matches to be output. Segmenting the input digital medium and determining matches for the segments in addition to identifying matches for the whole medium also enables a more accurate digital media matching process, as derivations or modifications of the digital medium which only use part of the medium are still able to be identified by this process. Furthermore, as the segmented medium is also compared on the basis of variations and modifications of the segmented medium, for example, where a segment of an input image is used, and then it is also modified by warping the scale of the segment, the methods for matching between the media are still able to accurately identify similarities, even despite extreme transformation and warping, and output direct matches from the database.

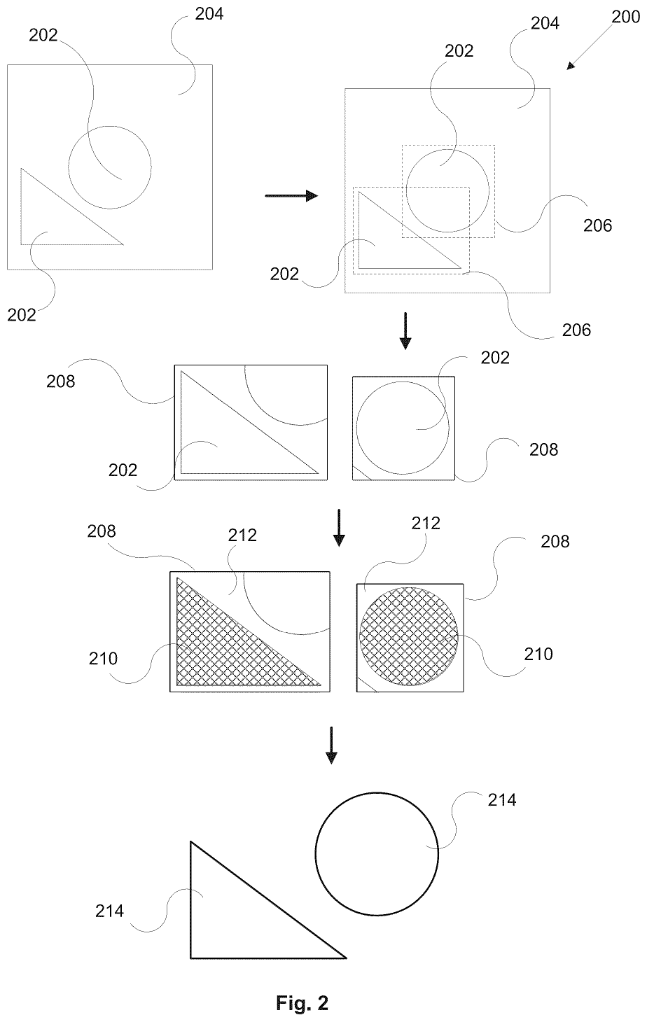

FIG. 3 is a process flow diagram of a method 300 for determining similarities between images, according to some embodiments. The method 300 includes, at 310, determining an input image for comparison with a plurality of stored images in a media database. The input image may include the selection or upload of an input image that is intended for comparison against a collection of stored images within a media database. Similar to step 102 of method 100, the input image may be received through a web application or client application, such as an online portal. In some embodiments, the input image may be received from an external database, selected for input by a selection means, or accessed from another system. In some embodiments, the system may extract the image from a database and/or data store. In one example, a user may upload an input image through a client application using the methods described herein. A preprocessing and/or pre-validation step may be performed to analyse whether the image meets minimum requirements for comparison.

At 320, the input image is vectorised to determine an input image vector representation. This may be the same or a similar step to 104 of method 100. In some embodiments, vectorising the input image may include feeding the input image into a deep learning model, such as a CLIP (Contrastive Language-Image Pretraining) encoder. In embodiments where the digital media is not an image type, for example where the medium is audio, video or text, another deep learning model encoder may be used which is suitable for the type of media and/or which is trained to vectorise the type of input medium. The CLIP encoder is configured to encode digital media, such as the input image, into a one dimensional (1D) vector. In some embodiments, the 1D vector may have a dimensionality of 768. In some embodiments, the 1D vector may have another dimensionality.

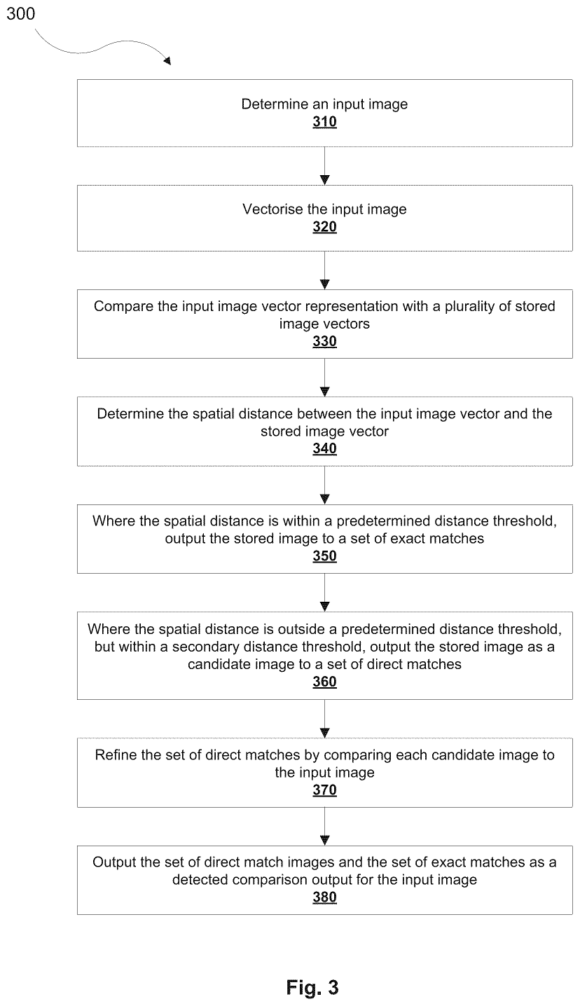

FIG. 4 is a diagram illustrating image vectorisation, according to some embodiments, for example, as performed at 320 of method 300. An input image 402, is fed into an encoder 404, which may be a CLIP encoder. The encoder 404 produces a vector representation 406.

The process of encoding an input image 402 into a 1D vector 406 using the CLIP encoder 404 may start with image preprocessing. In some embodiments, the input image is resized to a standard dimension, and normalised. For example, the encoder may be normalised using mean and standard deviation values specific to the dataset on which the encoder was trained. This normalisation ensures that the pixel values of the input image 402 are scaled appropriately. The pre-processed image is then fed into a convolutional neural network (CNN) to extract hierarchical features from the image through a series of convolutional layers. These layers capture various levels of abstraction, from low-level edges and textures to high-level semantic concepts.

Once the feature extraction is complete, the resulting feature map, which is a multi-dimensional tensor, undergoes a flattening process. Flattening of the resulting feature map involves converting the multi-dimensional tensor into a single-dimensional array by concatenating all the feature values. This transforms the spatially organised features into a format suitable for subsequent linear operations. The flattened vector is then passed through a linear projection layer, which is a fully connected layer with a fixed number of output neurons. This layer is trained to map the high-dimensional feature vector into a lower-dimensional embedding space, thereby generating a 1D vector 406.

Transformation and/or modifications of images such as minor colour variations, style variations and cropping, will still result in a substantially similar and/or the same encoded vector as the vector of the original image. For example, where the cropped part of an image comprises a large or major part of the original image and/or where the cropped part is the main object of the original image, the encoded vectors of such images will still be considered spatially close and/or substantially similar to the original image. However, the similarity of vectors generated from variations of images cannot be guaranteed because deep learning models, such as the CLIP encoder, inevitably operate using a black box model that generates encoded vectors without providing explicit interpretability or transparency in the decision-making process. As such, the method 300 includes further comparison analysis.

Referring back to FIG. 3, at 330, the input image vector representation is then compared with each of the plurality of stored images in a media database, by comparing the input image vector representation with a respective stored vector representation of each of the stored images. In some embodiments, the stored vector representations for each of the stored images are vectors which have been encoded by the same deep learning model. If two images are visually similar, their vectors will be close together in this vector space, indicating a potential match. If two images are identical, they will have the same vector. In some embodiments, the input image vector representation is compared with vector representations of each of the plurality of stored images. In some embodiments, the media database may comprise a database of stored images along with vector representations of the stored images. In some embodiments, the media database may have access to, or be in communication with, a secondary database which stores the vector representations for each of the plurality of stored images. In some embodiments, the media database may be a vector database.

For each stored image, at 340, a spatial distance between the input image vector representation and the stored vector representation of the stored image is determined. In some embodiments, determining the spatial distance between the vector representations may comprise calculating the proximity in the vector space between the input image and the closest stored image in the media database. The spatial distance may be determined by calculating the Euclidean distance between the two vectors. If the distance between the vectors is lower than a predetermined threshold, then the stored image corresponding to the stored vector representation is returned as an exact match to the input image. The predetermined threshold may be defined in terms of Euclidean distance. In some embodiments, the predetermined threshold for spatial distance is 25. In some embodiments, the predetermined threshold for spatial distance may be between 0 and 50. The predetermined threshold value allows for a tolerance of potential differences resulting from resolution and minor colour variations. At 350, responsive to the spatial distance between the input image vector representation and the stored vector representation of the stored image being within the predetermined distance threshold, the stored image is output as an exact match image to a set of exact matches, wherein the stored image is categorised as an exact match to the input image. The set of exact matches may include none, one or multiple exact matches. Where multiple stored images are within the predetermined distance threshold, multiple stored images may be categorised as exact matches.

At 360, responsive to the spatial distance between the input image vector representation and the vector representation of the stored image being outside of the predetermined distance threshold, but within a secondary predetermined distance threshold, the stored image is output as a candidate image to a set of direct matches. Candidate images may refer to images which have the potential to be a direct match of the image, but are distinct from an exact match. For example, candidate images may include images which are similar in some aspect, that is, they are a candidate for a direct match to the input image but may require further comparison analysis. Candidate images may be determined based on being outside of the predetermined distance threshold, and therefore not an exact match to the input image, but within a secondary distance threshold, and therefore may be considered similar or a direct match to the input image. The secondary distance threshold may define a secondary distance boundary around the input image vector representation, within which the stored vector representations are located. In some embodiments, the secondary distance threshold may refer to a predetermined number of the closest stored vectors. For example, in some embodiments, the secondary distance threshold may define that, after exact matches, the next 10 closest stored vector representations should be determined as candidate images to be output to the set of direct matches. In some embodiments, the secondary distance threshold may be defined in terms of Euclidean distance, for example, by taking the next 10 closest vectors based on Euclidean distance from the input vector representation, or the next closest vectors within a specified distance from the input vector representation. By identifying the closest vectors as candidate images, the processing time for matching images and/or determining whether the candidate images are relevant is significantly reduced, improving the speed at which the database is queried and matches can be identified.

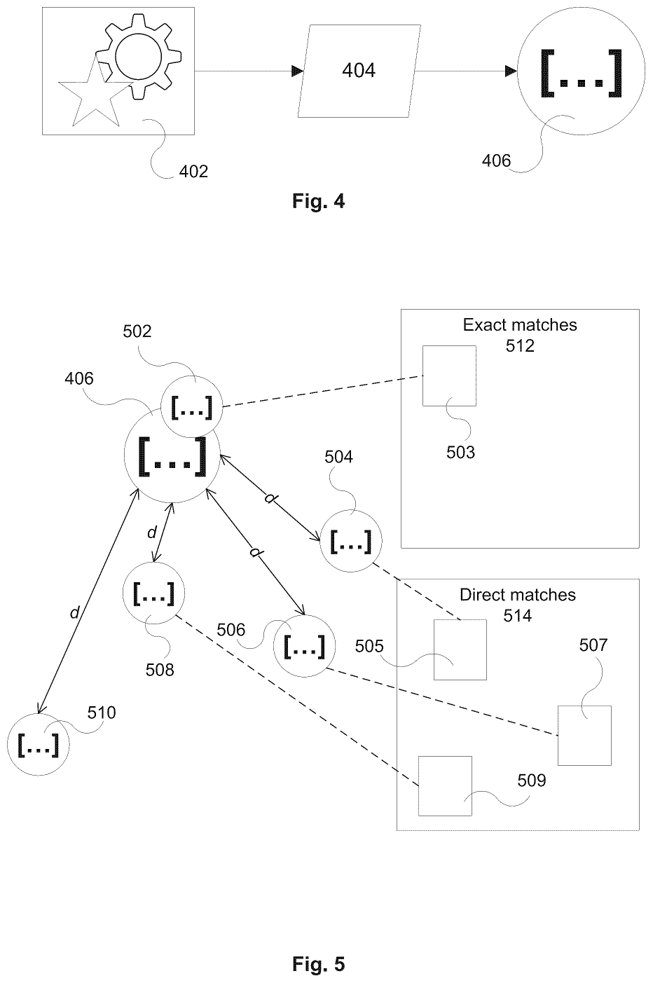

FIG. 5 is a diagram of a comparison of input vector representations and stored vector representations, according to some embodiments. The image input vector representation 406 is compared with the stored vector representations 502, 504, 506, 508, 510 in accordance with 340, 350 and 360 of method 300. After determination of the spatial distance (d) between the input vector representation 406 and the stored vector representations 502, 504, 506, 508, 510, it is determined that the stored vector representation 502 is very close to the input image vector representation 406, and is therefore determined to be within the predetermined distance threshold. As the stored vector 502 is within the predetermined distance threshold, the stored image 503 corresponding to the stored vector 502 is output as an exact match image to a set of exact matches 512. Stored vector representations 504, 506, 508 are determined to be outside the predetermined distance threshold, but within the secondary predetermined distance threshold, and therefore the stored images corresponding to the stored vectors 504, 506, 508 are output as candidate images 505, 507, 509 to the set of direct matches 514. Stored vector 510 is determined to have a calculated spatial distance outside of the secondary predetermined distance threshold. As such, stored vector is not output to the set of exact matches 512 or the set of direct matches 514.

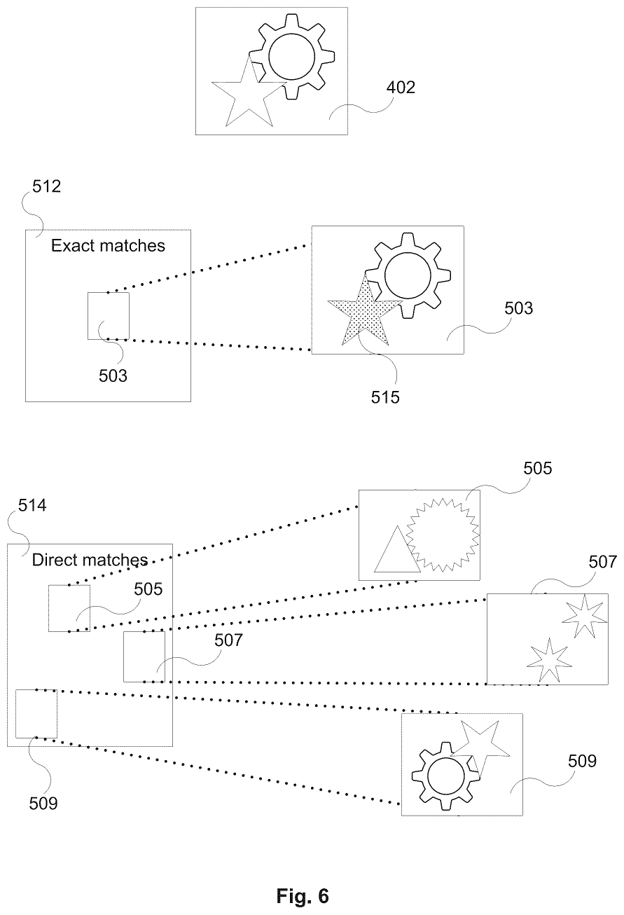

FIG. 6 is a diagram of the set of exact matches 512 and the set of direct matches 514 output as a result of the vector comparison in FIG. 5, according to some embodiments. In the set of exact matches 514, one stored image 503 has been identified as an exact match image. The exact match image 503 is substantially similar to the input image 402, but has some minor colour variation in one element 515. In the set of direct matches 514, three candidate images 505, 507, and 509 have been identified as potentially matching the input image 402. The candidate images 505, 507, 509 for the direct matches 514 are similar in some way to the input image 402, but further comparison analysis as to the similarity of the candidate images 505, 507, 509 and input image 402 may be required to refine the set of direct matches 514.

Referring back to FIG. 3, at 370, the set of direct matches is refined by comparing each candidate image in the set of direct matches to the input image. The comparison may be based on at least one of key points, alignment and structural similarity between the input image and the candidate image. In some embodiments, refining the set of direct matches may include removing candidate images from the set, and/or verifying a candidate image's similarity to the input image. In some embodiments, refining the set of direct matches comprises resizing each candidate image to the same scale as the input image. Resizing the images to the same scale mitigates, and in some cases substantially erases, the effect of resolution changes.

In some embodiments, refining the set of direct matches comprises generating one or more variations of the input image, and comparing the one or more variations of the input image to each of the candidate images. Generating a variation of the input image may include applying a transformation to all or part of the input image. In some embodiments, generating a variation of the input image may include editing all or part of the input image. In some embodiments, the transformation may include at least one of rotating, scaling, flipping, warping, cropping, inverting, blurring, and sharpening the input image and/or the candidate image. In some embodiments, the transformation may further include adjusting at least one of subclass, grayscale, brightness, contrast, hue, saturation, and luminosity of the input image and/or the candidate image. In some embodiments, the transformation may further include applying histogram equalisation, noise addition, sepia tone, one or more filters, a watermark, and/or a frame to the input image and/or the candidate image.

In some embodiments, refining the set of direct matches may comprise generating a variation of each candidate image, and adding the variation of each candidate image to the set of direct matches for comparison with the input image. Generating a variation of each candidate image may include applying a transformation to the candidate image. This may be useful where it is not possible to transform or edit the input image to create variations for comparison. By creating variations of the candidate images within the set, this can significantly reduce the amount of data required to be stored in the media database, as variations of candidate images do not have to be stored in the database at all times and may be created only when needed. Such variations of candidate images may also be stored temporarily in the set of direct matches, and/or may be deleted upon determination that they are not similar enough to the input image.

In some embodiments, refining the set of direct matches comprises generating a horizontally flipped version of the input image and/or a vertically flipped version of the input image. The flipped variations of the input image can then each be compared with each of the candidate images. In some embodiments, refining the set of direct matches comprises generating a horizontally flipped version of each candidate image and/or a vertically flipped version of each candidate image and adding these to the set of direct matches for comparison with the input image.

Comparing each candidate image to the input image based on at least one of key points, alignment and structural similarity can refine the set of direct matches by determining whether a threshold level of similarity is met, and removing candidate images that are not similar enough to the input image on the basis of these similarity attributes.

In some embodiments, comparing each candidate image in the set of direct matches to the input image based on at least key points includes applying a computer vision algorithm, such as Scale Invariant Feature Transform (SIFT) to extract a plurality of key points within the input image, and applying SIFT to extract a plurality of key points within each candidate image. SIFT identifies key points in an image that are invariant to scale, rotation, and illumination changes. Key points, which may also be referred to as local features, are specific points in an image that are used to identify and describe distinct regions within the image. The SIFT algorithm operates by constructing a scale space, which involves generating a series of smoothed and progressively blurred images. This process helps in identifying potential key points that are stable across different scales. These key points are then localised by finding extrema in the blurred images, which highlight regions of interest by subtracting one blurred image from another. The key points are further refined to ensure stability and accuracy, discarding low-contrast points and edge responses.

Once the key points are identified, SIFT generates descriptors that uniquely characterise the local image regions around each key point. This may include computing the gradient magnitude and orientation in the surrounding area to create a histogram of gradient directions. The resulting descriptor is a 128-dimensional vector that encapsulates the local image structure, making it highly distinctive and resilient to various transformations. A determination is then made on the number of key points which geometrically align between the key points of the input image and the key points of each candidate image. Candidate images from the set of direct matches where the number of geometrically aligned key points between an input image and a candidate image is below a predefined threshold, that is, where the number of geometrically aligned key points is low, can be removed from the set of direct matches. A FLANN (Fast Library for Approximate Nearest Neighbors) algorithm may be used for matching of the key points. A RANSAC (RANdom SAmple Consensus) algorithm may be used to determine the number of geometrically aligned key points between the input image and the candidate image.

In some embodiments, comparing each candidate image in the set of direct matches to each variation of the input image based on at least key points comprises applying Scale Invariant Feature Transform (SIFT) to extract a plurality of key points within each variation of the input image, for example, the horizontally flipped version and the vertically flipped version of the input image. Then, applying SIFT to extract a plurality of key points within each candidate image. The number of key points which geometrically align between the key points of each variation of the input image and the key points of each candidate image is determined, and candidate images which have a level of geometrically aligned points below a predetermined threshold are removed from the set of direct matches.

In some embodiments, comparing each candidate image in the set of direct matches to the input image based on at least alignment includes aligning the candidate images to have the same orientation as the input image, and applying SIFT to the aligned candidate images to extract a plurality of key points within each aligned candidate image. In some embodiments, alignment may be performed by warping the images to ensure they are in the same orientation. Images with simple colour and shape are filtered out due to a low number (or incorrect matching) of key points and the effects of warping.

The number of key points which geometrically align between the key points of the input image and the key points of each aligned candidate image are determined. Candidate images from the set of direct matches where the number of geometrically aligned key points between the input image and an aligned candidate image is below a predefined threshold are removed from the set of direct matches.

In some embodiments, comparing each candidate image in the set of direct matches to the input image based on at least structural similarity includes calculating a structural similarity index (SSIM) between the input image and each candidate image.

Candidate images from the set of direct matches where the SSIM between the input image and a candidate image is below a predefined threshold are removed from the set of direct matches. In some embodiments, colour variation in images may result in low SSIM so a relatively low predetermined threshold may be used. In other embodiments, before calculating an SSIM, the images may be converted to grayscale. For example, a grayscale version of the input image and each candidate image may be generated in order to calculate the SSIM.

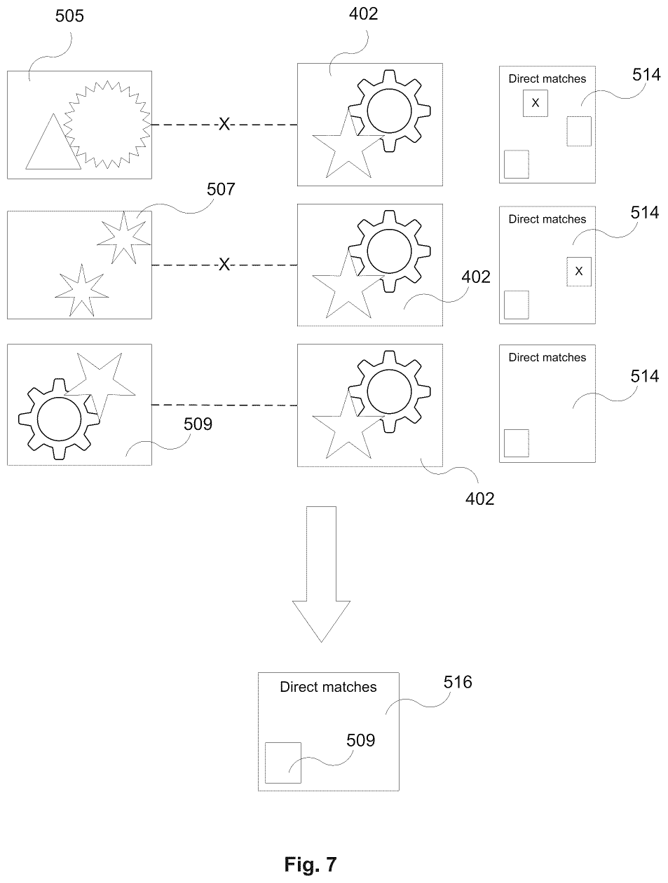

FIG. 7 is a diagram of the refinement of the set of direct matches 514 of FIG. 6, according to some embodiments. Each of the candidate images 505, 507, 509 is compared against the input image 402. For example, the comparison may be performed based on at least one of key points, alignment and structural similarity. In the embodiment shown in FIG. 7, the comparison is based on structural similarity. First, candidate image 505 is compared against input image 402. A structural similarity index (SSIM) is calculated, and the SSIM is determined to be below a predetermined threshold. As such, candidate image 505 is not considered a direct match to input image 402, and candidate image 505 is removed from the set of direct matches 514. Next, candidate image 507 is compared against input image 402. The SSIM is calculated, and the SSIM is determined to be below a predetermined threshold. As such, candidate image 507 is not considered a direct match to the input image 402, and candidate image 507 is removed from the set of direct matches 514. Finally, candidate image 509 is compared with input image 402. The SSIM is calculated, and the SSIM is determined to be above a predetermined threshold. As such, candidate image 509 is considered to be a direct match to input image 402, and remains in the set of direct matches 514. After the comparison is finished, the resulting set of direct matches is a refined set of direct matches 516 which includes the candidate image 509.

Referring back to FIG. 3, at 380, the set of direct matches which has been refined and the set of exact matches are output as a detected comparison output for the input image. In some embodiments, the comparison output may include associated information about the similarity of each of the exact matches and direct matches. For example, the comparison output may include, for each exact match, the associated spatial distance between the input image and the exact match. In another example, the comparison output may include, for each direct match, the associated number of geometrically aligned key points between the input image and the direct match.

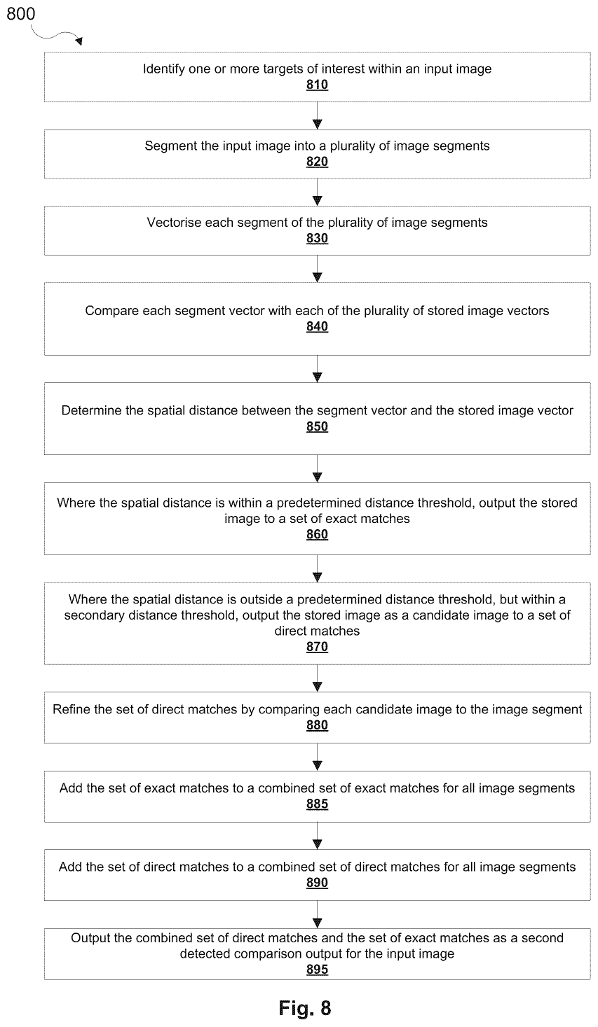

A segmentation method 800 may be performed simultaneously to, or as part of, the image comparison in method 300. FIG. 8 is a process flow diagram of a method 800 for determining similarities between image segments and stored images, according to some embodiments. Method 800 includes, at 810, identifying one or more targets of interest within an input image. The input image may be the same input image received at 310 of method 300. At 820, the input image is segmented into a plurality of image segments based on the targets of interest. This segmentation may comprise a similar process to that described herein with reference to 124 of method 120. At 830, each of the plurality of image segments is vectorised to determine a respective image segment vector representation. The vectorisation process for the plurality of image segments may be a similar or the same as the process with reference to 320 of method 300.

At 840, each of the image segment vector representations is compared with each of the plurality of stored images in the media database. The comparison comprises, for each of the plurality of image segments, determining a spatial distance between each image segment vector representation and a stored vector representation of the stored image at 850. Responsive to the spatial distance between an image segment vector representation and a stored vector representation being within a predetermined distance threshold, the stored image is output to a set of exact matches at 860. In some cases, there may be no exact matches, one exact match or a plurality of exact matches determined for each image segment. This may be a similar approach to determining the exact matches for the input image in 350 of method 300. In some embodiments, a set of exact matches may be created for each of the plurality of image segments.

At 870, responsive to the spatial distance between an image segment vector representation and a stored vector representation being outside of the predetermined distance threshold, but within a secondary predetermined distance threshold, the stored image is output as a candidate image to a set of direct matches. In some cases, there may be no direct matches, one direct match or a plurality of direct matches determined for each image segment. This may be a similar approach to determining the candidate images for the input image in 360 of method 300. In some embodiments, a set of direct matches may be created for each of the plurality of image segments. In other embodiments, the exact matches and the direct matches may be output directly to a combined set of exact matches and a combined set of direct matches for all of the image segments. The combined set of exact matches of the combined set of direct matches may be partitioned based on each candidate image's association with a respective image segment.

In some embodiments, the set of exact matches and set of direct matches associated with the input image may be combined with the set of exact matches and the set of direct matches associated with the plurality of image segments. The combined sets may then be processed, refined and/or output in accordance with methods described herein, such as 370 and 380 of method 300.

At 880, the set of direct matches associated with an image segment is refined by comparing each candidate image in the set with the associated image segment. The comparison may be based on at least one of key points, alignment and structural similarity.

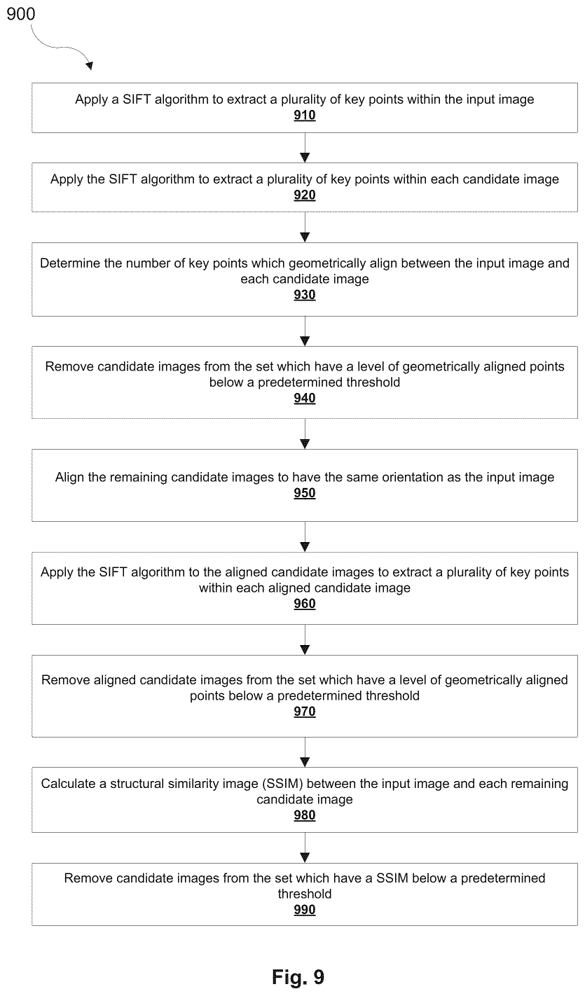

FIG. 9 is a process flow diagram of a method 900 for refining a set of direct matches, according to some embodiments. Method 900 may form part of step 370 of method 300 or step 880 of method 800 as described herein. Although method 900 is described with reference to an input image, it may also be applied to a segment of an input image. The method 900 includes, at 910, applying a Scale Invariant Feature Transform (SIFT) algorithm to extract a plurality of key points within the input image. At 920, the SIFT algorithm is applied to extract a plurality of key points within each candidate image. Then, the number of key points which geometrically align between the key points of the input image and the key points of each candidate image is determined at 930. Candidate images which have a level of geometrically aligned points below a predetermined threshold are removed from the set of direct matches in 940. At 950, the remaining candidate images are aligned to have the same orientation as the input image. The SIFT algorithm is applied to the aligned candidate images to extract a plurality of key points within each aligned candidate image at 960. Aligned candidate images which have a level of geometrically aligned points below a predetermined threshold are removed from the set of direct matches in 970. At 980, a structural similarity index (SSIM) between the input image and each remaining candidate image is calculated. Candidate images from the set of direct matches where the SSIM between the input image and a candidate image is below a predefined threshold are removed from the set of direct matches at 990.

Referring back to FIG. 8, at 885, the sets of exact matches associated with each image segment are added and/or appended to a combined set of exact matches for all image segments. At 890, the sets of direct matches associated with each image segment are added and/or appended to a combined set of direct matches for all image segments. 885 and 890 may be performed iteratively such that, as each image segment is compared with the stored images, the set of exact matches and the set of direct matches is added to the combined set of exact matches and the combined set of direct matches, respectively. In some embodiments, 885 and 890 may be performed after all image segments have been compared with the stored images. For example, all sets of exact matches for each image segment are combined into a single combined set of exact matches, and all sets of direct matches for each image segment, once refined, are combined into a single combined set of direct matches.

At 895, the combined set of direct matches and the combined set of exact matches for the plurality of image segments are output as a second detected comparison output for the input image. In some embodiments, the combined set of direct matches and the combined set of exact matches are added to the detected comparison output produced in 380 of method 300, so as to provide a single detected comparison output for both the input image and the plurality of segments of the input image.

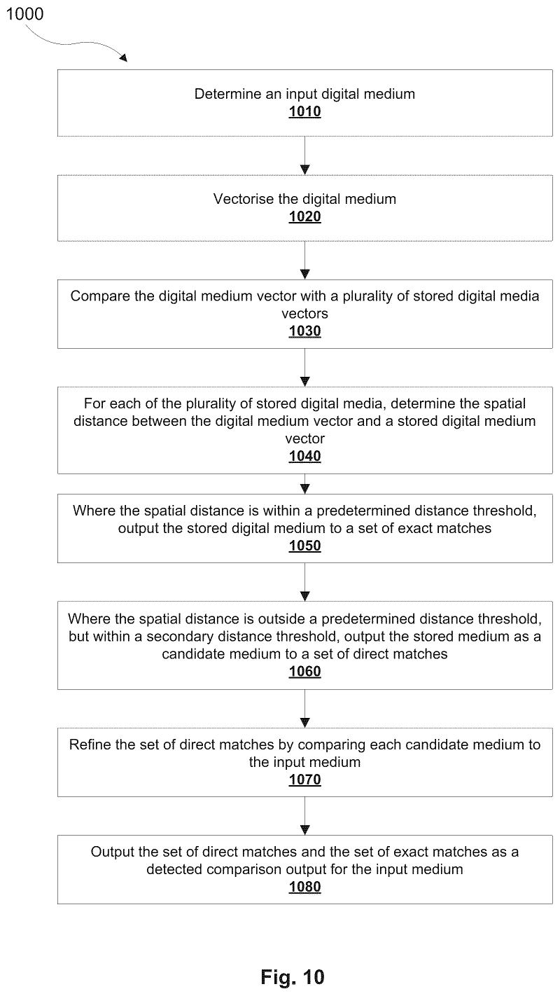

Although the methods 100, 120, 300, 800, and 900 described herein have referred to determining similarities between images, it will be appreciated that the methods may be applied to other forms of digital media, including, but not limited to, audio, video and text-based media. FIG. 10 is a process flow diagram of a method 1000 for determining similarities between digital media, according to some embodiments. The method 1000, includes at 1010 determining an input digital medium for comparison with a plurality of stored digital media in a media database.

At 1020, the digital medium is vectorised to determine an input digital medium vector representation. At 1030, the input digital medium vector representation is compared with each of the plurality of stored digital media in a media database. The comparison comprises, for each of the plurality of stored digital media, determining a spatial distance between the digital medium vector representation and the stored vector representation of a stored digital medium at 1040. Responsive to the spatial distance between the input image vector representation and the vector representation of the stored digital medium being within a predetermined distance threshold, the stored digital medium is output as an exact match medium to a set of exact matches at 1050. Responsive to the spatial distance between the input digital medium vector representation and the stored vector representation of the stored medium being outside of the predetermined distance threshold, but within a secondary predetermined distance threshold, the stored medium is output as a candidate medium to a set of direct matches at 1060.

At 1070, the set of direct matches may be refined by comparing each candidate medium with the input medium. Comparing each candidate medium with the input medium may include applying techniques appropriate for the type of digital media being compared. For example, audio-based media may be compared using techniques including, but not limited to, time-domain analysis, waveform comparison, cross-correlation, frequency-domain analysis, Fourier transform, spectrogram analysis, dynamic time warping (DTW), statistical measures (such as mean squared error and signal-to-noise ratio), Mel-Frequency Cepstral Coefficients (MFCCs), perceptual evaluation of speech quality, phase analysis (such as phase difference), envelope comparison (such as amplitude envelope), key point analysis and feature matching, bitrate comparison and format comparison.

In further examples, video and/or animation type media may be compared using techniques including, but not limited to, file hashing, frame-by-frame comparison, metadata comparison, audio comparison, histogram comparison, SSIM, Peak Signal-to-Noise Ratio (PSNR), feature matching using key points, motion vector comparison and content-based video retrieval (CBVR). Text-based media may be compared using techniques including, but not limited to, file hashing, string matching, text chunking, cosine similarity, Jaccard similarity, Levenshtein distance, semantic analysis, syntactic analysis, and stylometric analysis.

At 1080, the set of direct matches and the exact matches are output as a detected comparison output for the respective input medium.

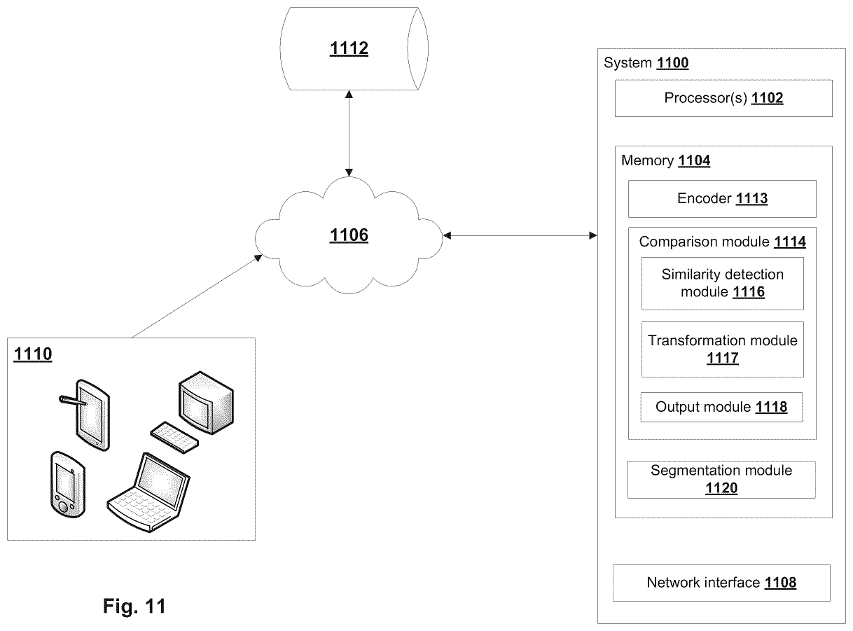

FIG. 11 is a block diagram of a system 1100 configured to perform the methods 100, 120, 300, 800, 900 and/or 1000, according to some embodiments. The system 1100 may be configured to perform methods 100, 120, 200, 300, 800, 900 and/or 1000 as described herein. The system 1100 may be configured to perform methods 100, 120, 200, 300, 800, 900 and 1000 may be performed in parallel, simultaneously or sequentially. The system 1100 comprises one or more processor(s) 1102 and memory 1104. The processor(s) 1102 may include integrated electronic circuits that perform calculations, and may include a microprocessor, for example. The processor(s) 1102 may comprise one or more microprocessors, graphic processing units (GPUs), central processing units (CPUs), application specific instruction set processors (ASIPs), application specific integrated circuits (ASICs) or other processors capable of reading and executing instruction code.

Memory 1104 may comprise one or more volatile or non-volatile memory types. For example, memory 1104 may comprise one or more of random access memory (RAM), read-only memory (ROM), electrically erasable programmable read-only memory (EEPROM) or flash memory. Memory 1104 comprises program code (for example, configured to store executable code modules or engines), accessible by the processor(s). When executed by the processor(s) 1102, the program code provides the various computational capabilities and functionality of the system 1100, causing the system to perform certain functionalities, which are described herein. In some embodiments, memory 1104 stores instructions (such as program code) which when executed by the processor(s) 1102 causes the system 1100 to perform methods for determining similarities between media and/or to function according to the methods described herein.

In some embodiments, the system 1100 may be implemented as a distributed system comprising multiple server systems configured to communicate over a network to provide the functionality of the system 1100. For example, one or more of the program code(s) (for example modules or engines) may be deployed on one or more disparate or remote servers, which may cooperate to provide the functionality of the system 1100 described. In some embodiments, the system 1100 may be in communication with a network 1106, and include a network interface 1108 to facilitate communication with additional components, including computing device(s) 1110, and one or more data stores 1112. The network interface 1108 may comprise a combination of network interface hardware and network interface software suitable for establishing, maintaining and facilitating communication over a relevant communication channel.

The one or more data stores 1112 may form part of or be local to the system 1100, or may be remote from and accessible to the system 1100, for example, through the network 1106. The one or more data stores 1112 may be relational or non-relational databases. In some embodiments, the data store 1112 may be a media database, configured to store a plurality of media, for example, a plurality of images.

The system may further include an encoder (or a vectorisation module) 1113, configured to encode an input digital medium, such as an input image, into a vector representation. The system may further include a comparison module 1114. The comparison module 1114 may be in communication with the encoder 1113, and configured to receive the vector representation of the input. The comparison module 1114 is configured to compare an input medium, such as an input image, with a plurality of stored media in a media database. The comparison module 1114 may be configured to perform 330, 340, 350, 360 and/or 370 of method 300, 840, 850, 860, 870, 880, 885, and/or 890 of method 800, 910, 920, 930, 940, 950, 960, 970, 980, and/or 990 of method 900, and/or 1030, 1040, 1050, 1060, 1070 of method 1000 as described herein. The comparison module 1114 may be configured to compare the input image vector representation with each of the plurality of stored images in a media database 1112. The comparison module 1114 may include a similarity detection module 1116 for performing the comparison. The similarity detection module may form part of the comparison module 1114. For example, the similarity detection module 1116 may be configured to calculate the spatial distance between the input image vector representation and the respective stored image, to identify exact matches and/or direct matches. The similarity detection module 1116 may output the exact matches to the output module 1118. The similarity detection module may output the direct matches as a set of direct matches and continue comparing the set of direct matches with the input image. In some embodiments, the similarity detection module 1116 may be configured to compare the input image with stored images based on at least one of key points, alignment and/or structural similarity. In some embodiments, the similarity detection module 1116 may be in communication with a transformation module 1117. The transformation module 1117 may be configured to apply transformations and/or modifications to the input image and/or the candidate images in the set of direct matches for further comparison analysis. The comparison module 1114 may include an output module 1118 which is configured to receive the results of the similarity detection from the similarity detection module 1116 and output a detected comparison output for the respective input image and the stored images. In some embodiments, the similarity detection module 1116, the transformation module 1117, and/or the output module 1118 may form part of the comparison module 1114, or they may be separate modules in communication with the comparison module 1114.

The system 1100 may further include a segmentation module 1120, configured to identify one or more targets of interest within the input image and segment the input image into a plurality of image segments based on the targets of interest. For example, the segmentation module 1120 may be configured to perform process 200 of FIG. 2. The segmentation module may be configured to perform steps 124 and 125 of method 120, and/or steps 810 and 820 of method 800 as described herein. The segmentation module 1120 may be in communication with the comparison module 1114 to transmit the resulting segmented media to the comparison module 1114 for comparison.

The methods described herein may be used within a system for detecting copyright of intellectual property infringement. For example, the system may be configured to receive an input image, for example, from a user, and compare the input image against a plurality of stored images in a media database, where the plurality of stored images are known copyrighted works. The system may be configured to compare the input image to the plurality of stored images using methods 100, 120, 300, 800, 900 and/or 1000. Where a comparison output indicates that there is a high degree of similarity between an input image or a segment of an input image, and all or part of a stored image, the system may be configured to output a flag that there is potential infringement in the input image. In some embodiments, the system may be configured to query whether a stored image which has a high degree of similarity to an input image has a registered form of intellectual property, and/or identify the party that owns the intellectual property. The system may also be configured to determine whether the input image or stored image is in the public domain.

In some embodiments, the system may be configured to compare, segment and track an input image after it has been processed. For example, if the input image is determined not to have a high similarity to any stored images, the input image (and its corresponding input image segments) may then be stored in the media database for comparison to future input images. Additionally, in some embodiments, the system may be configured to utilise crawlers, such as web crawlers, which are able to crawl databases, web applications and the like for images to be compared to the input image. In some embodiments, crawlers are implemented on specific web applications, such as web pages, for infringement screening purposes. Crawlers are configured to crawl the images from the web applications to generate new media for the media database. In some embodiments, crawlers may be able to crawl images from web applications to generate media to input into the image matching methods described herein, for infringement detection. This enables instances of the input image which appear outside of the media database to be identified and located, for example, in order to determine whether infringement of intellectual property rights has occurred. The system may be configured to utilise an AI algorithm to generate derivative works of the input image or identify image segments, or stored images, to use for additional points of comparison, in order to identify if all or part of an input image is using a known copyrighted work or identify if derivative works are being used elsewhere when tracking the input image.

In some embodiments, the system may further include an application to test for copyright infringement by using a large language model (LLM) to contextualize real licensing terms, machine learning models and algorithms to test asset and composite works against known published works, and machine learning models to create composite assets from an original asset.

The methods for determining similarities between digital media as described herein may be implemented as part of methods for tracking and/or monitoring digital media ownership, authorship, copyright and/or provenance. For example, the methods described herein for comparing images including methods 100, 120, 200, 300, 800, 900 and/or 1000 may be used in methods for associating digital media with provenance information.

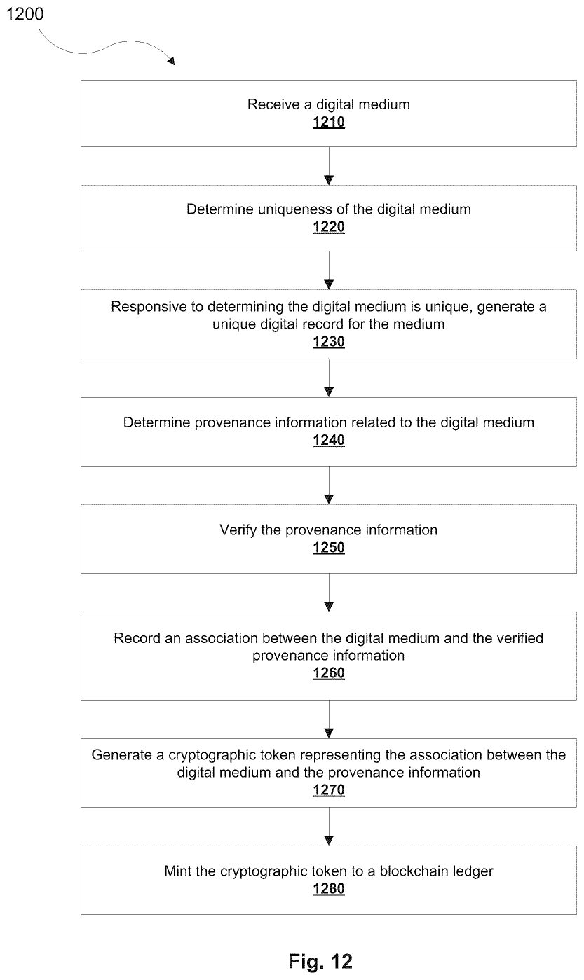

FIG. 12 is a process flow diagram of a method for associating digital media with provenance information, according to some embodiments. The method 1200 comprises, at 1210, receiving a digital medium to be associated with provenance information. The digital medium may be received through a system, such as being uploaded to a system 1100 or 1300. Alternatively, the digital medium may be extracted from an external data source, such as a database, or obtained from an external system. At 1220, the uniqueness of the digital medium is determined. The uniqueness is determined by comparing the received digital medium with stored digital media in a database. For example, determining the uniqueness of the digital medium may include performing a medium screening and/or matching process, such as those described herein with reference to methods 100, 120, 200, 300, 800, 900 and 1000. When the comparison output from comparing the medium to a media database returns no exact or direct matches, the medium is determined to be unique. The comparison ensures that the digital medium is unique and not a duplicate, modification, variation, exact match or direct match of any existing media. The uniqueness may refer to whether the digital medium is an original work.

Once the uniqueness of the digital medium is verified, at 1230, the method 1200 generates a unique digital record for the medium. This may include creating a distinct identifier for the digital medium. In some embodiments, this may include storing the digital medium in a database as a unique record. At 1240, the method determines the provenance information related to the digital medium. This may include identifying and retrieving the relevant provenance information to be associated with the digital medium. In some embodiments, the provenance information may be information related to the provenance of the digital medium, and may include, but is not limited to, authorship information, country of origin, creation details and timelines, publication details and timelines, and the like. In some embodiments, determining the provenance information may include at least one of establishing an authorship relation between the digital medium and the author, establishing an ownership relationship between the digital medium and a verified entity, and obtaining a timeline of creation and/publication details. In some embodiments, the determination of the provenance information may be performed across multiple distinct steps, or they may be performed as one step in the method 1200.

After determining the provenance information, the provenance information of the digital medium is verified at 1250. In some embodiments, verifying the provenance information of the digital medium comprises determining the details associated with the creation of the digital medium and/or publication of the medium. The verification may also include verifying the authorship information and ownership information. In some embodiments, verifying the authorship information or ownership information may include checking that such information is consistent with the details associated with creation or publication of the medium. In some embodiments, the verification of provenance information, including authorship and/or ownership information, may be manually reviewed and approved.

At 1260, an association between the digital medium and the provenance information is recorded. This association is recorded such that it writes a link between the digital medium and its corresponding provenance information. Recording the association establishes a clear and verifiable link between the digital medium and its provenance. At 1270, a cryptographic token is generated, wherein the cryptographic token represents the association between the digital medium and the provenance information. This may also be referred to as tokenising the asset, or asset tokenisation. This cryptographic token serves as a verified, tokenised copyright asset, providing a secure and tamper-proof representation of the relationship between the digital medium and its provenance. Asset tokenisation may include creating a digital representation of the medium as a token on a blockchain. Provenance information, including authorship information, ownership rights and metadata related to the digital medium (such as details about the creation and/or publication timelines) may be encoded into the token.

At 1280, the cryptographic token is minted to a blockchain ledger. Minting comprises adding the cryptographic token to a blockchain ledger, creating an immutable record of the association between the digital medium and the provenance information. The use of the blockchain ledger creates a record that cannot be altered, thereby providing a high level of security and trust in the information within the token. The immutable record may be referenced at any time to verify the association between the digital medium and the provenance information.

In some embodiments, the method may further include establishing an ownership link between the digital medium and a verified entity by using a verification process for ownership information. The ownership link may be tokenised and minted to the blockchain ledger as part of the transaction history of the tokenised copyright asset associated with the digital medium, allowing ownership of the digital medium to be accurately reflected. This can be particularly beneficial where copyright ownership changes and/or is different from the original author (for example, where estates may own copyrighted media or where the copyright is sold and/or transferred).

The method may further comprise associating metadata with the cryptographic token. The metadata may include additional information about the digital medium, its copyright status and/or its provenance information. The metadata associated with the cryptographic token may be updated to reflect any changes in the copyright status of the digital medium. In some embodiments, this may be updated automatically, for example, where the term of copyright expires and media enters the public domain. In some embodiments, these updates may be a result of a change or recorded transaction related to the digital media. For example, where the ownership is transferred or the digital media is licensed to another entity.

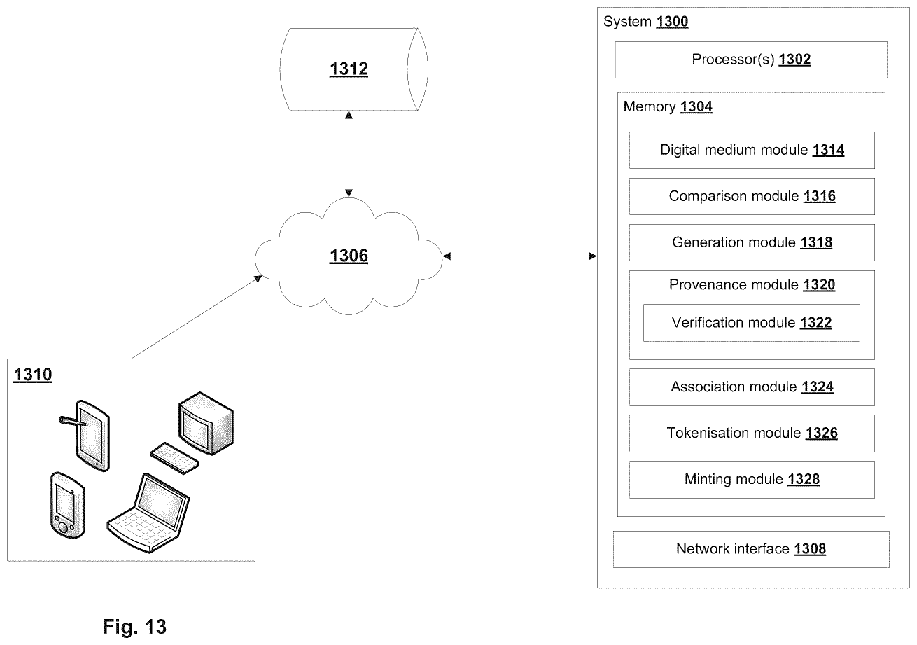

FIG. 13 is a block diagram of a system 1300 configured to perform the method 1200 for associating digital media with provenance information, according to some embodiments. In some embodiments, the system 1300, may also be configured to perform methods 100, 120, 300, 800, 900 and 1000 as described herein. The system 1300 comprises one or more processor(s) 1302 and memory 1304. The processor(s) 1302 may include integrated electronic circuits that perform calculations, and may include a microprocessor, for example. The processor(s) 1302 may comprise one or more microprocessors, graphic processing units (GPUs), central processing units (CPUs), application specific instruction set processors (ASIPs), application specific integrated circuits (ASICs) or other processors capable of reading and executing instruction code.

Memory 1304 may comprise one or more volatile or non-volatile memory types. For example, memory 1304 may comprise one or more of random access memory (RAM), read-only memory (ROM), electrically erasable programmable read-only memory (EEPROM) or flash memory. Memory 1304 comprises program code (for example, configured to store executable code modules or engines), accessible by the processor(s). When executed by the processor(s) 1302, the program code provides the various computational capabilities and functionality of the system 1300, causing the system to perform certain functionalities, which are described herein. In some embodiments, memory 1304 stores instructions (such as program code) which when executed by the processor(s) 1302 causes the system 1300 to perform methods for determining similarities between media and/or to function according to the methods described herein, including methods 100, 120, 200, 300, 800, 900, and 1200.

In some embodiments, the system 1300 may be implemented as a distributed system comprising multiple server systems configured to communicate over a network to provide the functionality of the system 1300. For example, one or more of the program code(s) (for example modules or engines) may be deployed on one or more disparate or remote servers, which may cooperate to provide the functionality of the system 1300 described. In some embodiments, the system 1300 may be in communication with a network 1306, and include a network interface 1308 to facilitate communication with additional components, including computing device(s) 1310, and one or more data stores 1312. The network interface 1308 may comprise a combination of network interface hardware and network interface software suitable for establishing, maintaining and facilitating communication over a relevant communication channel.

The one or more data stores 1312 may form part of or be local to the system 1300, or may be remote from and accessible to the system 1300, for example, through the network 1306. The one or more data stores 1312 may be relational or non-relational databases. In some embodiments, the data store 1312 may be a media database, configured to store a plurality of digital media.

The system 1300 may include a digital media module 1314, configured to receive, extract and/or otherwise determine a digital medium to be associated with provenance information. The digital media module 1314 may be configured to perform steps 102 of method 100, and/or 310 of method 300. The digital media module may be in communication with a comparison module 1316, and may be configured to transmit the received digital medium to the comparison module 1316. The comparison module may be the same or similar to comparison module 1114 of system 1100. In some embodiments, the comparison module 1316 may comprise the system 1100, or be in communication with the system 1100. The comparison module 1316 may be configured to determine the uniqueness of the digital medium by comparing it with stored digital media in the media database 1312. The comparison module 1316 may be configured to performed methods 100, 120, 200, 300, 800, 900 and 1000 as described herein. The comparison module may be configured to perform step 1220 of method 1200 as described herein. The comparison module 1316 determines and confirms that the received digital medium is unique and not a match to existing media in the database 1312.

Upon verifying the uniqueness of the digital medium, the comparison module 1316 outputs the result to a generation module 1318. The generation module 1318 receives the result from the comparison module 1316 and, responsive to verifying the uniqueness of the digital medium, the generation module 1318 is configured to generate a unique digital record for the digital medium. In some embodiments, the generation module 1318 may perform step 1230 of method 1200. The system further includes a provenance module 1320, configured to determine provenance information associated with or related to the digital medium. The provenance module 1320 may be configured to determine authorship information, ownership information, country of origin, and creation and/or publication timelines related to the digital medium. The provenance module 1320 may be configured to perform step 1240 of method 1200. Upon determining the provenance information, the provenance module 1320 may be configured to transmit the provenance information to a verification module 1322. The verification module 1322 is configured to verify the provenance information, and/or verify the association between the provenance information and the digital medium. The verification module 1322 may be configured to perform step 1250 of method 1200. In some embodiments, verification module 1322 may form part of the provenance module 1320, or may be external to, and in communication with, the provenance module 1320.

An association module 1324 then receives the verified provenance information from the verification module 1322, and records the association between the digital medium and the verified provenance information. The association module 1324 may be configured to record and/or write the association to a database or data structure. The association module may be configured to perform step 1260 of method 1200. The system further includes a tokenisation module 1326 which is configured to receive the association record and create a cryptographic token representing the association record as a verified copyright asset. The tokenisation module 1326 may be configured to perform step 1270 of method 1200. The token may then be transmitted to a minting module 1328, which is configured to mint the cryptographic token onto a blockchain ledger, creating an immutable record of the association. The minting module 1328 may be configured to perform step 1280 of method 1200.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

### Example Clauses

A: A method, including: determining an input image for comparison with a plurality of stored images in a media database; vectorizing the input image to determine an input image vector representation of the input image; comparing the input image vector representation with each of the plurality of stored images in a media database, wherein said comparing comprises, for each of the plurality of stored images: determining a spatial distance between the input image vector representation and the respective stored image; and determining a comparison output for the respective input image vector representation and the stored image pair based on the spatial distance; returning the comparison output for each of the respective input image vector representation and the stored image pairs when the comparison output exceeds a predetermined threshold.
B: The method as clause A recites, further including: identifying one or more targets of interest within the input image; segmenting the input image into a plurality of image segments based on the targets of interest; vectorizing each of the plurality of image segments to determine respective image segment vector representations; comparing each of the image segment vector representations with each of the plurality of stored images in the media database, wherein said comparing comprises, for each of the plurality of stored images; determining a spatial distance between each image segment vector representation and each of the plurality of stored images; and determining a comparison output for each of the respective image segment vector representation and the stored image pair based on the spatial distance; returning the comparison output for each of the respective image segment vector representation and the stored image pairs when the comparison output exceeds a predetermined threshold.
C: The method as either clause A or clause B recites, wherein segmenting the input image into a plurality of image segments includes: splitting the input image into a plurality of smaller images based on the identified targets of interest; and detecting boundaries in each of the smaller images around the targets of interest and segmenting the target of interest from the smaller image to define an image segment.
D: The method as any one clauses A to C recites, wherein comparing the input image vector representation with a plurality of stored images in a media database includes calculating a spatial distance between the image vector representation and vectors of the plurality of stored images.
E: The method as any one clauses A to D recites, wherein calculating a spatial distance includes using one or more of: (i) Euclidean distance; (ii) Hamming distance; (iii) Manhattan distance; and (iv) Minkowski distance.
F: The method as any one clauses A to E recites, wherein the targets of interest are identified by an object detection algorithm or object detection model.
G: The method as clause F recites, wherein the object detection model is an open-set object detector.
H: The method as clause G recites, wherein the open-set object detector is grounding DINO.
I: The method as clause H recites, wherein the input image is segmented using a segmentation model.
J: The method as clause I recites, wherein the segmentation model is SAM (Segment Anything Model).
K: The method as clause B or clause C recites, wherein Grounded-SAM is used to segment the input image.
L: The method as any one clauses A to K recites, wherein comparing the image vector representation and the stored images uses one or more of pixel values, colour histograms, an opencv detection algorithm and/or a convolutional neural network.
M: The method as any one clauses A to L recites, wherein the comparison output includes a similarity measure.
N: The method as any one clauses A to M recites, wherein returning the comparison output includes returning the stored image of the respective input image vector representation and the stored image pair.
O: The method as any one clauses A to N recites, wherein comparison outputs are collated into a list, wherein the list contains all comparison outputs for the input image and each of the stored images which exceed the predetermined threshold.
P: A system, including: one or more processors; and memory comprising computer executable instructions, which when executed by the one or more processors, cause the system to perform the methods as any one of clauses A to O recite.
Q: A computer-readable storage medium storing instructions that, when executed by a computer, cause the computer to perform the methods as any one of clauses A to O recite.
R: A method, including: determining a digital medium for comparison with a plurality of stored media in a media database; vectorising the digital medium to determine a digital medium vector representation; comparing the digital medium vector representation with each of the plurality of stored media in the media database, wherein said comparing comprises, for each stored medium of the plurality of stored media: determining a spatial distance between the digital medium vector representation and a stored vector representation of the stored medium; and responsive to the spatial distance between the digital medium vector representation and the stored vector representation being within a predetermined distance threshold, outputting the stored medium as an exact match medium to a set of exact matches; responsive to the spatial distance between the digital medium vector representation and the stored vector representation being outside of the predetermined distance threshold, but within a secondary predetermined distance threshold, outputting the stored medium as a candidate medium to a set of direct matches; refining the set of direct matches by comparing each candidate medium in the set of direct matches to the digital medium; outputting the set of direct matches and the set of exact matches as a detected comparison output for the digital medium.
S: A method, including: determining an input image for comparison with a plurality of stored images in a media database; vectorising the input image to determine an input image vector representation; comparing the input image vector representation with each of the plurality of stored images in the media database, wherein said comparing comprises, for each stored image of the plurality of stored images: determining a spatial distance between the input image vector representation and a stored vector representation of the stored image; and responsive to the spatial distance between the input image vector representation and the stored vector representation being within a predetermined distance threshold, outputting the stored image as an exact match image to a set of exact matches; responsive to the spatial distance between the input image vector representation and the stored vector representation being outside of the predetermined distance threshold, but within a secondary predetermined distance threshold, outputting the stored image as a candidate image to a set of direct matches; refining the set of direct matches by comparing each candidate image in the set of direct matches to the input image based on at least one of key points, alignment and structural similarity; and outputting the set of direct matches and the set of exact matches as a detected comparison output for the input image.
T: The method as clause S recites, further including: identifying one or more targets of interest within the input image; segmenting the input image into a plurality of image segments based on the targets of interest; and vectorising each of the plurality of image segments to determine respective image segment vector representations.
U: The method as clause T recites, further comprising: comparing each of the image segment vector representations with each of the plurality of stored images in the media database.
V: The method as clause U recites, wherein comparing each of the image segment vector representations with each of the plurality of stored images, comprises, for each of the plurality of image segments: determining a spatial distance between an image segment vector representation and a stored vector representation of a stored image for each of the plurality of stored images; responsive to the spatial distance between the image segment vector representation and the stored vector representation being within a predetermined distance threshold, outputting the stored image as an exact segment match to a set of exact segment matches; responsive to the spatial distance between the image segment vector representation and the stored vector representation being outside of the predetermined distance threshold, but within a secondary predetermined distance threshold, outputting the stored image as a candidate image to a set of direct segment matches associated with the image segment.
X: The method as clause V recites, further comprising, for each of the plurality of image segments: refining the set of direct segment matches associated with the image segment by comparing each candidate image to the image segment based on at least one of key points, alignment and structural similarity; adding the set of exact segment matches associated with the image segment to a combined set of exact segment matches; adding the set of direct segment matches associated with the image segment to a combined set of direct segment matches.
Y: The method as clause X recites: outputting the combined set of image segment direct matches and the combined set of exact matches for the plurality of image segments as a second detected comparison output for the input image.
Z: The method as any one of clauses T to Y recites, wherein segmenting the input image into a plurality of image segments includes: splitting the input image into a plurality of smaller images based on the identified targets of interest; and detecting boundaries in each of the smaller images around the targets of interest; and segmenting the target of interest from the smaller image to define an image segment.
AA: The method as any one of clauses T to Z recites, wherein the targets of interest are identified by an object detection algorithm or object detection model.
AB: The method as any one of clauses T to AA recites, wherein the input image is segmented using a segmentation model.
AC: The method as clause AB recites wherein the segmentation model is SAM (Segment Anything Model).
AD: The method as any one of clauses S to AC recites, wherein comparing the input image vector representation with a plurality of stored images in a media database includes comparing the input image vector representation to a stored image vector representation.
AE: The method as any one of clauses S to AD recites, wherein comparing the input image vector representation to a stored image vector representation comprises calculating a spatial distance between the input image vector representation and the stored image vector representation.
AF: The method as clauses AE recites, wherein calculating a spatial distance includes using Euclidean distance.
AG: The method as any one of clauses S to AF recites, wherein refining the set of direct matches comprises resizing each candidate image to the same scale as the input image.
AH: The method as any one of clauses S to AG recites, wherein refining the set of direct matches comprises: generating one or more variations of each candidate image; and adding the one or more variations of each candidate image to the set of direct matches for comparison with the input image.
AI: The method as clauses AH recites, wherein generating one or more variations of each candidate image may include applying a transformation to the candidate image.
AJ: The method as any one of clauses S to AI recites, wherein refining the set of direct matches comprises: generating one or more variations of the input image; and comparing the one or more variations of the input image to each of the candidate images.
AK: The method as clause AJ recites, wherein generating one or more variations of the input image comprises applying a transformation to the input image.
AL: The method as clause AK recites, wherein the transformation includes at least one of rotating, scaling, flipping, warping, cropping, inverting, blurring, and sharpening the input image.
AM: The method as clause AK or clause AL recites, wherein the transformation comprises adjusting at least one of subclass, grayscale, brightness, contrast, hue, saturation, and luminosity of the input image.
AN: The method as any one of clauses AJ to AM recites, wherein the transformation comprises applying at least one of histogram equalisation, noise addition, sepia tone, one or more filters, a watermark, and/or a frame to the input image.
AO: The method clauses AK recites, wherein generating one or more variations of the input image comprises generating a horizontally flipped variation of the input image and a vertically flipped variation of the input image.
AP: The method as any one of clauses S to AO recites, wherein comparing each candidate image in the set of direct matches to the input image based on at least key points comprises: applying Scale Invariant Feature Transform (SIFT) to extract a plurality of key points within the input image; applying SIFT to extract a plurality of key points within each candidate image; and determining the number of key points geometrically align between the key points of the input image and the key points of each candidate image.
AQ: The method as clauses AP recites, wherein refining the set of direct matches further comprises removing candidate images from the set of direct matches where the number of geometrically aligned key points between an input image and a candidate image is below a predetermined threshold.
AR: The method as any one of clauses S to AQ recites, wherein comparing each stored image in the set of direct matches to the input image based on at least alignment comprises: aligning each candidate image to have the same orientation as the input image; applying SIFT to the aligned candidate images to extract a plurality of key points within each aligned candidate image; and determining the number of key points that geometrically align between the key points of the input image and the key points of each aligned candidate image.
AS: The method as clause AR recites, wherein refining the set of direct matches further comprises removing candidate images from the set of direct matches where the number of geometrically aligned key points between the input image and an aligned candidate image is below a predetermined threshold.
AT: The method as any one of clauses S to AS recites, wherein comparing each stored image in the set of direct matches to the input image based on at least structural similarity comprises: calculating a structural similarity index (SSIM) between the input image and each candidate image.
AU: The method as clauses AT recites, wherein refining the set of direct matches further comprises removing candidate images from the set of direct matches where the SSIM between the input image and a candidate image is below a predetermined threshold.
AV: The method as any one of clauses S to AU recites, wherein the comparison output includes a similarity measure.
AW: The method as any one of clauses S to AV recites, wherein the detected comparison outputs are collated into a list, wherein the list contains all elements in the set of exact matches and the set of direct matches.
AX: A system, including: one or more processors; and memory comprising computer executable instructions, which when executed by the one or more processors, cause the system to perform the method as any one of clause S to AW recites.
AY: A computer-readable storage medium storing instructions that, when executed by a computer, cause the computer to perform the method as any one of clause S to AW recites.
AZ: A system, including: an encoder, configured to: determine an input image for comparison with a plurality of stored images in a media database; and vectorise the input image to determine an input image vector representation; a comparison module, configured to: compare the input image vector representation with each of the plurality of stored images in a media database, wherein said comparing comprises, for each stored image of the plurality of stored images: determine a spatial distance between the input image vector representation and a stored vector representation of the stored image; and responsive to the spatial distance between the input image vector representation and the stored vector representation being within a predetermined distance threshold, output the stored image as an exact match image to a set of exact matches; responsive to the spatial distance between the input image vector representation and the stored vector representation being outside of the predetermined distance threshold, but within a secondary predetermined distance threshold, output the stored image as a candidate image to a set of direct matches; refine the set of direct matches by comparing each candidate image in the set of direct matches to the input image based on at least one of key points, alignment and structural similarity; and an output module, configured to output the set of direct matches and the set of exact matches as a detected comparison output for the input image.
BA: A computer-readable medium storing instructions that, when executed by a processor, cause the processor to perform a method comprising: determining an input image for comparison with a plurality of stored images in a media database; vectorising the input image to determine an input image vector representation; comparing the input image vector representation with each of the plurality of stored images in a media database, wherein said comparing comprises, for each stored image of the plurality of stored images: determining a spatial distance between the input image vector representation and a stored vector representation of the stored image; and responsive to the spatial distance between the input image vector representation and the stored vector representation being within a predetermined distance threshold, outputting the stored image as an exact match image to a set of exact matches; responsive to the spatial distance between the input image vector representation and the stored vector representation being outside of the predetermined distance threshold, but within a secondary predetermined distance threshold, outputting the stored image as a candidate image to a set of direct matches; refining the set of direct matches by comparing each candidate image in the set of direct matches to the input image based on at least one of key points, alignment and structural similarity; and outputting the set of direct matches and the set of exact matches as a detected comparison output for the input image.
BB: A method for associating digital media with provenance information, comprising: receiving a digital medium to be associated with provenance information; determining the uniqueness of the digital medium by comparing the digital medium with the stored digital media in the database; responsive to verifying the uniqueness of the digital medium, generating a unique digital record for the digital medium; determining provenance information related to the digital medium; verifying the provenance information; writing an association between the digital medium and the provenance information; generating a cryptographic token representing the association between the digital medium and the provenance information as a verified copyright asset; minting the cryptographic token to a blockchain ledger to create an immutable record.
BC: The method as clause BB recites, wherein the digital medium is an image, video, or audio recording.
BD: The method as clause BB or clause BC recites, wherein the provenance information includes at least one or authorship information, ownership information, creation information, publication information, and/or time stamps associated with the digital media.
BE: The method as any one of clauses BB to BD recites, further comprising verifying the provenance information of the digital medium by determining details associated with creation of the digital medium and/or publication of the digital medium.
BF: The method as any one of clauses BB to BE recites, further comprising, verifying the provenance information of the digital medium by verifying the authorship information and/or ownership information.
BG: The method clauses BF recites, further comprising establishing an ownership link between the digital medium and a verified entity based on the verified ownership information.
BH: The method as any one of clauses BB to BG recites, further comprising associating metadata with the cryptographic token, wherein the metadata includes information about the digital medium and/or the copyright status of the digital medium.
BI: The method as any one of clauses BB to BH recites, further comprising enabling the transfer of ownership of the cryptographic token through blockchain transactions.
BJ: The method as any one of clauses BB to BI recites, further comprising providing a mechanism for updating the metadata associated with the cryptographic token to reflect any changes in the copyright status of the digital medium.
BK: The method as any one of clauses BB to BJ recites, further comprising determining authorship information from the provenance information, and constructing one or more Generative Artificial Intelligence (GenAI) models by training the model with a set of one or more digital media associated with the same authorship information, wherein the one or more GenAI models are configured to generate one or more AI-derived digital media.
BL: The method as clause BK recites, wherein the set of one or more digital media associated with the same authorship information is used to create a digital fingerprint associated with the authorship information.
BM: The method as clause BL recites, wherein the digital fingerprint is used to configure the one or more GenAI models to generate one or more AI-derived digital media having a substantially similar style of digital media associated with the digital fingerprint.
BN: The method as clause BM recites, wherein the method further includes providing a mechanism for generating one or more AI-derived digital media using the one or more trained GenAI model.
BO: The method as any one of clauses BK to BN recites, wherein the method further includes establishing an authorship link between the one or more AI-derived digital media and the authorship information; generating a cryptographic token representing each of the one or more AI-derived digital media and the authorship link as a verified copyright asset; and minting the cryptographic token onto a blockchain ledger to create an immutable record of the authorship associated with each of the one or more AI-derived digital media.
BP: A system for associating digital media with author information, comprising: a digital medium module configured to receive a digital medium to be associated with provenance information; a comparison module configured to determine the uniqueness of the digital medium by comparing the digital medium with the stored digital media in a database; a generation module configures to, responsive to verifying the uniqueness of the digital medium, generate a unique digital record for the digital medium; a provenance information module configured to determine provenance information related to the digital medium; a verification module configured to verify the provenance information; an association module configured to write an association between the digital medium and the verified provenance information; a tokenisation module configured to generate a cryptographic token representing the association between the digital medium and the provenance information as a verified copyright asset; and a minting module configured to mint the cryptographic token to a blockchain ledger to create an immutable record.
BQ: A computer-readable storage medium storing instructions that, when executed by a computer, cause the computer to perform the method as any one of clauses BB to BP recites.

1. A method, including:
determining an input image for comparison with a plurality of stored images in a media database;
vectorising the input image to determine an input image vector representation;
comparing the input image vector representation with each of the plurality of stored images in a media database, wherein said comparing comprises, for each stored image of the plurality of stored images:
determining a spatial distance between the input image vector representation and a stored vector representation of the stored image; and
responsive to the spatial distance between the input image vector representation and the stored vector representation being within a predetermined distance threshold, outputting the stored image as an exact match image to a set of exact matches;
responsive to the spatial distance between the input image vector representation and the stored vector representation being outside of the predetermined distance threshold, but within a secondary predetermined distance threshold, outputting the stored image as a candidate image to a set of direct matches;
refining the set of direct matches by comparing each candidate image in the set of direct matches to the input image based on at least one of key points, alignment and structural similarity; and
outputting the set of direct matches and the set of exact matches as a detected comparison output for the input image.

2. The method according to claim 1, further including:
identifying one or more targets of interest within the input image;
segmenting the input image into a plurality of image segments based on the targets of interest; and
vectorising each of the plurality of image segments to determine respective image segment vector representations.

3. The method according to claim 2, further comprising:
comparing each of the image segment vector representations with each of the plurality of stored images in the media database.

4. The method according to claim 3, wherein comparing each of the image segment vector representations with each of the plurality of stored images, comprises, for each of the plurality of image segments:
determining a spatial distance between an image segment vector representation and a stored vector representation of a stored image for each of the plurality of stored images;
responsive to the spatial distance between the image segment vector representation and the stored vector representation being within a predetermined distance threshold, outputting the stored image as an exact segment match to a set of exact segment matches;
responsive to the spatial distance between the image segment vector representation and the stored vector representation being outside of the predetermined distance threshold, but within a secondary predetermined distance threshold, outputting the stored image as a candidate image to a set of direct segment matches associated with the image segment.

5. The method according to claim 4, further comprising:
refining the set of direct segment matches associated with the image segment by comparing each candidate image to the image segment based on at least one of key points, alignment and structural similarity;
adding the set of exact segment matches associated with the image segment to a combined set of exact segment matches;
adding the set of direct segment matches associated with the image segment to a combined set of direct segment matches;
outputting the combined set of image segment direct matches and the combined set of exact matches for the plurality of image segments as a second detected comparison output for the input image.

6. The method according to claim 2 wherein segmenting the input image into a plurality of image segments includes:
splitting the input image into a plurality of smaller images based on the identified targets of interest; and
detecting boundaries in each of the smaller images around the targets of interest; and
segmenting the target of interest from the smaller image to define an image segment.

7. The method according to claim 2, wherein the input image is segmented using a SAM (Segment Anything Model).

8. The method according to claim 1, wherein comparing the input image vector representation with each of the plurality of stored images in a media database comprises calculating a spatial distance between the input image vector representation and a stored image vector representation of each of the plurality of stored images.

9. The method according to claim 8, wherein calculating a spatial distance includes calculating Euclidean distance.

10. The method according to claim 1, wherein refining the set of direct matches comprises:
generating one or more variations of the input image; and
comparing the one or more variations of the input image to each of the candidate images.

11. The method according to claim 10, wherein generating one or more variations of the input image comprises applying a transformation to the input image.

12. The method of claim 11, wherein the transformation includes at least one of rotating, scaling, flipping, warping, cropping, inverting, blurring, and sharpening the input image, adjusting at least one of subclass, grayscale, brightness, contrast, hue, saturation, and luminosity of the input image, and/or applying at least one of histogram equalisation, noise addition, sepia tone, one or more filters, a watermark, and/or a frame to the input image.

13. The method according to claim 1, wherein comparing each candidate image in the set of direct matches to the input image based on at least key points comprises:
applying Scale Invariant Feature Transform (SIFT) to extract a plurality of key points within the input image;
applying SIFT to extract a plurality of key points within each candidate image; and
determining the number of key points geometrically align between the key points of the input image and the key points of each candidate image.

14. The method of claim 13, wherein refining the set of direct matches further comprises removing candidate images from the set of direct matches where the number of geometrically aligned key points between an input image and a candidate image is below a predetermined threshold.

15. The method according to claim 1, wherein comparing each stored image in the set of direct matches to the input image based on at least alignment comprises:
aligning each candidate image to have same orientation as the input image;
applying SIFT to the aligned candidate images to extract a plurality of key points within each aligned candidate image; and
determining number of key points that geometrically align between the key points of the input image and the key points of each aligned candidate image.

16. The method of claim 15, wherein refining the set of direct matches further comprises removing candidate images from the set of direct matches where the number of geometrically aligned key points between the input image and an aligned candidate image is below a predetermined threshold.

17. The method of claim 1, wherein comparing each stored image in the set of direct matches to the input image based on at least structural similarity comprises:
calculating a structural similarity index (SSIM) between the input image and each candidate image.

18. The method of claim 17, wherein refining the set of direct matches further comprises removing candidate images from the set of direct matches where the SSIM between the input image and a candidate image is below a predetermined threshold.

19. A system, including:
an encoder, configured to:
determine an input image for comparison with a plurality of stored images in a media database; and
vectorise the input image to determine an input image vector representation;
a comparison module, configured to:
compare the input image vector representation with each of the plurality of stored images in a media database, wherein said comparing comprises, for each stored image of the plurality of stored images:
determine a spatial distance between the input image vector representation and a stored vector representation of the stored image; and
responsive to the spatial distance between the input image vector representation and the stored vector representation being within a predetermined distance threshold, output the stored image as an exact match image to a set of exact matches;
responsive to the spatial distance between the input image vector representation and the stored vector representation being outside of the predetermined distance threshold, but within a secondary predetermined distance threshold, output the stored image as a candidate image to a set of direct matches;
refine the set of direct matches by comparing each candidate image in the set of direct matches to the input image based on at least one of key points, alignment and structural similarity; and
an output module, configured to output the set of direct matches and the set of exact matches as a detected comparison output for the input image.

20. A computer-readable medium storing instructions that, when executed by a processor, cause the processor to perform a method comprising:
determining an input image for comparison with a plurality of stored images in a media database;
vectorising the input image to determine an input image vector representation;
comparing the input image vector representation with each of the plurality of stored images in a media database, wherein said comparing comprises, for each stored image of the plurality of stored images:
determining a spatial distance between the input image vector representation and a stored vector representation of the stored image; and
responsive to the spatial distance between the input image vector representation and the stored vector representation being within a predetermined distance threshold, outputting the stored image as an exact match image to a set of exact matches;
responsive to the spatial distance between the input image vector representation and the stored vector representation being outside of the predetermined distance threshold, but within a secondary predetermined distance threshold, outputting the stored image as a candidate image to a set of direct matches;
refining the set of direct matches by comparing each candidate image in the set of direct matches to the input image based on at least one of key points, alignment and structural similarity; and
outputting the set of direct matches and the set of exact matches as a detected comparison output for the input image.
